(19) United States
(12) Patent Application Publication
(10) Pub. No.: US 2003/0144873 A1
(43) Pub. Date: Jul. 31, 2003

(54) Mobile marketing system

(76) Inventor: Michelle L. Keshel, Milwaukee, WI (US)

Correspondence Address: Michael J. Gratz, Boyle Fredrickson Newholm Stein & Gratz, S.C., Suite 1030, 250 E. Wisconsin Avenue, Milwaukee, WI, 53202, US

(21) Appl. No.: 10/348,047

(22) Filed: Jan. 21, 2003

Related U.S. Application Data
(60) Provisional application No. 60/349,767, filed on Jan. 18, 2002.

(51) Int. Cl. G06F 17/60

(52) U.S. Cl. 705/1

(57) ABSTRACT

A mobile marketing system is comprised of a remote access subsystem and support center subsystem. An initial contact data collection module is operationally connected to the remote access system and to a database for storing the contact data. A data management module is connected to the database for managing contact follow-up. A correspondence content manager and sequencer is connected to the database for purposes of automatically configuring user collection modules dynamically. A user data, preferences and signature database is linked to the data management module. A ROI module and a sales quote and configuration module are connected to the database for preparing ROI modeling and quotes for a prospect. A print module connected to the data management module to provide fulfillment through local and remote support center subsystems.

### CROSS-REFERENCE(S) TO RELATED APPLICATION(S)

This application claims a benefit of priority on U.S. Ser. No. 60/349,767, filed Jan. 18, 2002, now the entire contents of which are hereby expressly incorporated by reference into the present application.

### BACKGROUND OF THE INVENTION

1. Field of the Invention

The present invention relates in general to the field of automated marketing systems. More particularly, the present invention relates to a timesaving, remotely accessible, active lead marketing and fulfillment system.

2. Discussion of the Related Art

Traditional marketing systems and processes consist of primarily processes that are performed either manually or with the assistance of electronic word processors and/or databases designed to merge data and produce documents. For example, if new sales prospect is met, the parties normally exchange business cards. Back at the office, the sales representative typically prepares on a word processor a follow-up letter to the prospect and encloses additional information on the products or services offered. The prospect's name and contact information is likely then entered into a database. Sometime later, the sales representative may contact the prospect via telephone for a follow-up conference and perhaps scheduling a more formal sales meeting. An electronic scheduler may be used for follow-up reminders and meeting scheduling. Larger sales campaigns are generally handled in a less personal way and typically carried out by correspondence creation and a database mail merge. This is then followed by a mass mailing of usually impersonal form letters. The sales representative then often directly makes a personal follow-up contact with the prospect and tracks potential prospects until a sale is made.

More recently customer relationship management systems (CRM) have been developed. CRM systems include methodologies, software, and usually Internet capabilities that help electronically manage customer relationships in an organized way. For example, a company may build a database of its customers that describes relationships in sufficient detail so that management, salespeople, people providing service, and perhaps the customer directly may access information, match customer needs with product plans and offerings, remind customers of service requirements, know what other products a customer had purchased, and so forth. However, most CRM systems often only provide sales people with one tool in an area where many are needed.

The present invention combines the marketing and sales processes uniquely with a set of tasks consisting of original data entry of prospect information, development of sales forecast information, creating expense report updates, and managing correspondence fulfillment. It also eliminates the need to physically handle the resulting printed personalized correspondence multiple times because the correspondence is printed and handled as single document order by preferably a remote sales support center that services the user's subscription.

### SUMMARY AND OBJECTS OF THE INVENTION

A. Objects of the Invention

By way of summary, the present invention is directed to a mobile marketing system. A primary object of the invention is to provide an apparatus that links a sales manager and the manager's sales representative to a remote sales support center to generate follow-up marketing and sales correspondence, sales reports, and other potential customer specific documentation. One other objective of the present invention is to more fully-automate and customize marketing and sales systems.

Another object of the invention is to provide an apparatus that is ruggedized and reliable, thereby decreasing down time and operating costs. Another object of the invention is to provide an apparatus that has one or more of the characteristics discussed above but which is relatively simply to operate, manufacture and assemble using a minimum amount of effort and equipment. Yet another object of the invention is to provide a method that is predictable and reproducible, thereby decreasing variance and operating costs. Still another object of the invention is to provide a method that has one or more of the characteristics discussed above but which is relatively simple to setup and operate for new or minimally-trained workers.

These, and other objects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

B. Summary Description of the Invention

In accordance with one aspect of the invention, the above-mentioned objects are primarily achieved by providing a sales and marketing system that is preferably comprised of: a subscriber remote access subsystem having a server computer; a mobile marketing user subsystem having an access device, e.g., a computer, a wireless access device, a mobile phone, a laptop computer; and a sales support center subsystem having a server computer and a database.

In accordance with another aspect of the invention, these objects are achieved by a mobile marketing system and process that includes a remote access device to access or capture and follow-up on potential customer or active client leads. The software that drives this system and process will hereinafter be referred to as the “Mobile Marketer Active Lead Module” or “Mobile Marketing Module.” The Mobile Marketing Module preferably includes: (a) a global content management submodule; (b) a print submodule; (c) a signature placement submodule; (d) a photo placement submodule; (e) a data recall submodule; and (f) a print routing submodule.

In this way, the invention provides companies and individuals with a more convenient, less expensive and more effective method for:

Fulfilling the need to capture information related to customers, prospects and trading partners that is most often lost, misplaced or forgotten about;

Fulfilling the need to follow up in written and electronic correspondence formats with customers, prospects and trading partners;

Increasing the level of perceptual value for the company or individual in the mind of the customer, prospect or trading partner;

Fulfilling the need to direct to and deliver to customers, prospects and trading partners, situation specific information and testimonials that can be accessed in text, video or audio formats through Internet or wireless communications networks and devices;

Fulfilling the need to convey information related to situational specific pricing or product configuration information in written and electronic correspondence formats with customers, prospects and trading partners;

Fulfilling the need to convey information related to situational specific and proposed courses of action or recommendations in written and electronic correspondence formats with customers, prospects and trading partners;

Fulfilling the need to convey information related to situational specific contractual arrangements and agreements in written and electronic correspondence formats with customers, prospects and trading partners; and

Fulfilling the need to convey information related to situational specific events, intents, or acknowledgements in written and electronic correspondence formats with customers, prospects and trading partners.

The inventive system is also highly practical and parallels the thought/action processes used to correspond with and influence others in an automated fashion.

When the inventive subscriber subsystem is used, data entered by the system user through interactive and system specific forms is analyzed and interpolated for situational specificity by the sales support center subsystem and then merged into a dynamically assembled document or series of documents retrieved from a centralized data repository (preferably housed within the sales support center subsystem) that matches the interpreted situation according to a set of rules defined by the subscriber and/or user and a system operator.

Within the sales support subsystem, a reference to an Internet based video, audio and text formatted testimonials or instructions is preferably merged into the dynamically assembled document, again based on the interpolation of the data entered by the system user. The system user's signature is merged into the dynamic document from the centralized image storage repository and positioned with accuracy in such a manner as to look personally signed. Also inserted into the dynamic document are the user's photo, based on preference, and any element of data from the mobile marketing database which is tagged and formatted for insertion into the document.

The invention helps in achieving the following sales representative user's goals, e.g., delivering costs savings, increasing the ability of the user to create a favorable impression with his/her prospect, customer or trading partner, and capturing valuable information that is often lost. The invention is easier to use than current processes or methods for completing correspondence and data capture tasks.

In describing one preferred embodiment of the invention which is illustrated in the attached drawings, specific terminology will be resorted to for the sake of clarity. However, it is not intended that the invention be limited to the specific terms so selected and it is to be understood that each specific term includes all technical equivalents which operate in a similar manner to accomplish a similar purpose. For example, the word connected or terms similar thereto are often used. They are not limited to direct connection but include connection through other elements where such connection is recognized as being equivalent by those skilled in the art. Further, the words system, subsystem, module, and submodule are used to describe one relationship between various parts and processes within the invention. They should not however, be interpreted to mean that one part or process is more or less important than any other or be used to limit the invention to a single embodiment.

### BRIEF DESCRIPTION OF THE DRAWINGS

A clear conception of the advantages and features constituting the present invention, and of the construction and operation of typical mechanisms provided with the present invention, will become more readily apparent by referring to the exemplary, and therefore non-limiting, embodiments illustrated in the drawings accompanying and forming a part of this specification, wherein like reference numerals designate the same elements in the several views, and in which:

FIG. 1 is a diagram showing one embodiment of the present invention;

FIG. 2 is a schematic showing one module of one embodiment of the present invention;

FIG. 3 is a schematic showing potential interactive uses of one embodiment of the present invention;

FIG. 4 is a schematic showing how one embodiment of the present invention helps manage prospective sales campaigns;

FIG. 5 is a diagram illustrating one embodiment of the present invention;

FIG. 6 illustrates a piece of correspondence which can be generated by one embodiment of the present invention;

FIGS. 7A-C show how one embodiment of a jig of the present invention may work;

FIG. 8 is a schematic illustrating one embodiment of the sales support center subsystem;

FIG. 9 is a schematic of another embodiment of the sales support center subsystem;

FIG. 10 is a diagram illustrating various modules of the sales support center subsystem;

FIG. 11 shows one interface of one embodiment of the present invention;

FIG. 12 shows another interface of one embodiment of the present invention;

FIG. 13 illustrates another interface of one embodiment of the present invention;

FIG. 14 shows another interface of one embodiment of the present invention;

FIG. 15 shows another interface of one embodiment of the present invention;

FIG. 16 shows another interface of one embodiment of the present invention;

FIG. 17 shows another interface of one embodiment of the present invention;

FIG. 18 is a schematic showing two different types of interfaces for one embodiment of a mobile marketing module of the present invention;

FIG. 19 shows a schematic for one embodiment of the present invention;

FIG. 20 shows a flow diagram for one embodiment of the mobile marketing module interface of the present invention;

FIG. 20A shows the login interface for the mobile marketing module of one embodiment of the present invention;

FIG. 21 is a schematic showing various options available to a subscriber through a sales support center of one embodiment of the present invention;

FIGS. 22-25 show another module interface of one embodiment of the present invention;

FIGS. 26-29 show another module interface of one embodiment of the present invention;

FIG. 30 shows another module interface of one embodiment of the present invention;

FIG. 31 shows another module interface of one embodiment of the present invention;

FIG. 32 shows another feature of the user admin module interface of one embodiment of the present invention;

FIG. 33 shows another module interface of one embodiment of the present invention;

FIG. 34 shows another module interface of one embodiment of the present invention;

FIGS. 35 and 36 show a reports module interface of one embodiment of the present invention;

FIG. 37 is a schematic illustrating an example of the various options available through the present invention to a subscriber; and

FIG. 38 is a schematic showing weekly reporting module functions of the present invention.

### DESCRIPTION OF PREFERRED EMBODIMENTS

The present invention and the various features and advantageous details thereof are explained more fully with reference to the non-limiting embodiments described in detail in the following description.

1. Resume

The invention applies automation and artificial intelligence to combine a number of business workflow steps, functions, actions and labors into one, transaction-based, interactive process. The invention also provides a simplified system to access data and interface with it through any device in which a user can connect to an Internet or wireless data communications network. The invention further presents a unique business model for such a system.

The steps for the inventive process are individually defined as follows:

Database entry and/or recording of information related to persons and organizations that are met or discovered by persons performing marketing or sales functions;

Database entry and/or recording of correlated data related to probabilities of success at conducting business with persons and organizations that are met or discovered by persons performing marketing or sales functions;

Database entry and/or recoding of personal and organizational expenses related to the business activities of meeting, discovering or entertaining persons or organizations;

Preparing, printing, mailing and/or transmitting correspondence directed to persons or organizations met or discovered by persons and organizations performing marketing or sales functions that are situational specific and related to past, and future meetings, events or acknowledgements;

Preparing, printing, mailing and/or transmitting correspondence directed to persons or organizations met or discovered by persons and organizations performing marketing or sales functions that are situational specific and used to convey directions for the retrieval of information, instructions or testimonials delivered through printed, video and audio mediums;

Preparing, printing, mailing and/or transmitting correspondence directed to persons or organizations met or discovered by persons and organizations performing marketing or sales functions that are situational specific and used to convey information related to the price or required configuration of products and/or services;

Preparing, printing, mailing and/or transmitting correspondence directed to persons or organizations met or discovered by persons and organizations performing marketing or sales functions that are situational specific and used to convey information related proposed or recommended courses of action or intents; and

Preparing, printing, mailing and/or transmitting correspondence directed to persons or organizations met or discovered by persons and organizations performing marketing or sales functions that are situational specific and used to convey information related to specific Return on Investment Analysis reports as they relate to proposed or recommended courses of action and priced products, services or solutions.

Organizing of the environmental and economic facts set forth above into best courses of action and recommendations is complex. This is especially true with respect to the pricing and configuration of products and services by persons and organizations performing marketing or sales functions. The pricing and configuration of products and services must be accomplished in such a manner as to ensure that based on available products and services that the resulting final configuration most appropriately meets their prospect's and the business's needs. By using the inventive system, this can be done according to rules established by the business offering these products or services for sale, lease or consumption, including the logical interpretation of environmental and economic facts into descriptive instructions, language, calculations or symbols used to convey the proposition, information, or recommended course of action to the prospect.

The system allows a subscriber (usually the sales rep's sales director) to manage contact and prospect data and sales reps. It also allows sales rep users to send personalized correspondence, literature, marketing materials, and manage their own continuous one-to-one sales and marketing campaigns. These campaigns can be managed and driven from any remote location including: the office, home, hotel room, and even the golf course. The goal of the system is to save the subscriber valuable time and money while dramatically increasing sales activity of the user.

One key to the system's ability to quickly deploy any size sales force for the subscriber is this unique way in which it manages correspondence re-assembly and one-to-one personalization universally across the subscriber's sales force. For example, all of the subscriber's sales letter content, on-demand literature, and campaign content is stored in one centralized location. This centralized system with remote access allows the sales reps to manage their own prospects and target materials using, for example, a mobile ROLODEX.

The inventive system includes a mobile marketing subsystem that is an automated, customer relationship management tool that ties the user directly to a state of the art 24-hour, 365 days a year centralized location, e.g., a sales support center. A mobile marketing module of the subsystem connects a sales rep user to a sales support center via cellular phone, PDA or computer. The mobile marketing module also helps the user to be more professional and more productive. The mobile marketing module preferably operates as a web application through, for example, MS Internet Explorer, as an application for mobile devices that support WAP (Wireless Application Protocol), or as a J2ME module on Motorola iDEN phones using Nextel Network Aware add-on services for Nextel customers.

To begin using the system, a subscriber establishes a subscriber account with the sales support center. Once the subscriber signs up for the system, e.g., the mobile marketing system and sales support center on-demand services, a campaign manager assigns one or more writers and a campaign coordinator (e.g., a sales support center team) to the subscriber account. This team will help to structure and create a campaign having a set of automated personalized correspondence that is ideal for use with mobile marketing module. The sales support center team newly creates the sales documents and supporting materials for the subscriber, or alternatively, takes documents and materials that the subscriber has created or previously used in past campaigns, uploads them, and preps them for use through the sales support center.

The team must also work with user sales reps to capture each user's signature to be included on the user correspondence. Once the signature is captured, a photo may also be taken of the user to add an additional personal touch to the correspondence.

Once the content is deployed to the mobile marketing subsystem's servers, the subscriber and user control the support team's actions through the mobile marketing module software interfaces, e.g., web page interfaces.

Whenever changes or additions are needed to content or a specific campaign, dependent on the subscriber's location, this will be communicated either in person, telephonically, via Videoconference or through the interactive campaign design server and corresponding module.

The mobile marketing module is relatively easy to use. The user may be trained in its use in around 20 minutes. For example, after entering name and password information from a login page, the user learns to enter new prospect information or selects an existing prospect, and then chooses the correspondence the user desires to send.

Once selected, contact data for targeted prospects along with each sales reps personalized contact data, photograph/picture (optional), and signature are merged on-demand into each item of correspondence when daily production is run by the center via a sales support center subsystem. The correspondence or literature the user selects, including the user's personalized correspondence program is then entered, tracked, and fulfilled the same day. A fulfillment module includes creating the document, printing and then delivering it (usually to a traditional mail carrier, e.g., the U.S. Postal Service) so that it gets into the hands of the sales prospect as quickly as possible. Fulfillment is done by the sales support center. The center has the capability to add new sales reps to the system in minutes. This also gives the subscriber the capability to easily handle and deploy a sales force of 1, 100, or a 1,000 in preferably just a few days, and not weeks, and definitely not according to average CRM/Marketing System timelines-Months.

When the user uses the mobile marketing subsystem and the sales support center subsystem, the user's prospect preferably cannot tell that the user did not directly prepare the personalized correspondence that they are receiving. The content of the user correspondence is unique to the user, the user's company, the user's products, and preferably to the prospect so that it is truly personalized.

At the “back office” the sales support center manages the user's correspondence and the subscriber's campaigns with the sales support center subsystem using both technology and a staff of sales support experts, writers, fulfillment managers, and marketing specialists. Under one business model, the subscriber or user only pays for correspondence drafting services (one time) and then just for the correspondence the user sends. This may be done on a regular billing cycle, e.g., monthly, or by credit or debit card per transaction. The debit/credit card arrangement generally allows for more current expense account information.

The system also gives the user and subscriber the ability to manage item-by-item fulfillment schedules that consist of nearly any number of total correspondences with nearly any number of on-demand attachments; the ability to quickly change correspondence content to remain current with changing market conditions, new solutions, and new products; Item-by-Item, one-to-one campaign fulfillment billed on one price; and weekly call queue and campaign status reports.

Lead contact, campaign status, and call list reports are automatically transmitted to the user weekly and any other subscriber point of contact via the subscriber subsystem. For example, if the point of contact (POC) is the sales director or account manager, the POC user can have every one of the subscriber company's sales representatives reports rolled up into a consolidated report that transmits (via email or traditional mail) to the POC user. Reports may be gathered on-demand through the mobile marketing module web portal if the user wants reports with greater frequency. Alternatively, the reports are automatically compiled and transmitted direct to the sales rep user and/or subscriber POC each week so that they are always aware of where each of the prospects are on their individual campaign timelines. Reports also include contact information, campaign success information, and suggested call dates.

2. Detailed Description of Preferred Embodiment(s)

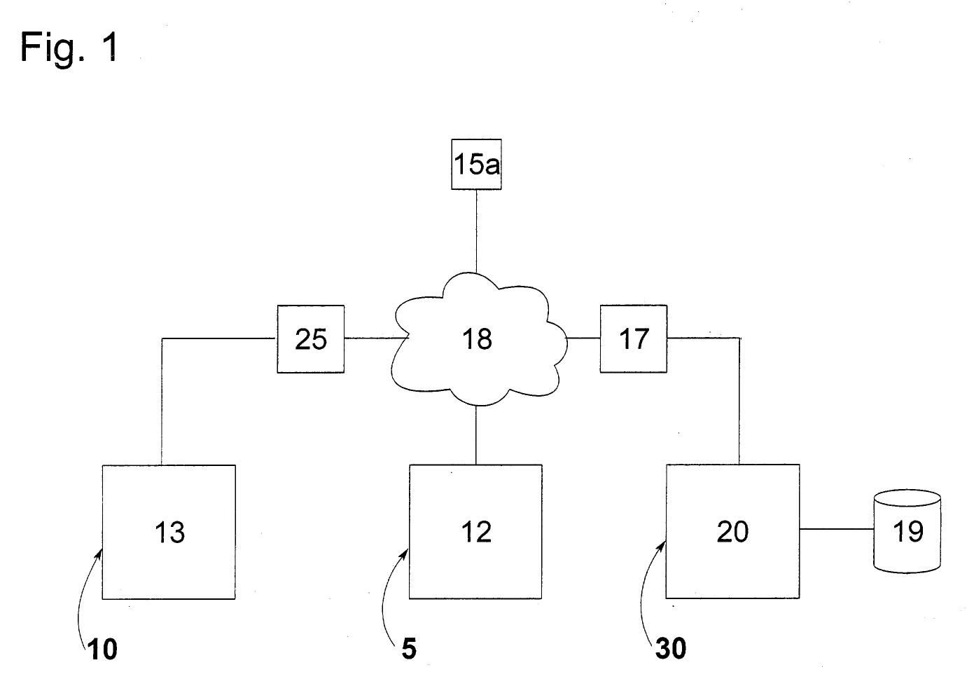

Preferably, as best illustrated in FIG. 1, the inventive system and process are used by a “subscriber” or corporate entity 5 that has employees that act as primary “users” or “correspondents” 10 of sales and marketing system 1. The subscriber 5 preferably has a back office subsystem 12 that makes the connection to the system 1. The user 10 uses device 13 to access system 1 through a subsystem 25.

At the beginning of each new sales effort, the subscriber works with a marketing group to develop a sales campaign for a particular product or service. Once a specific sales campaign approach is adopted, documents are created or identified to support the campaign and saved in database 19. The sales force is then introduced to the campaign and made familiar with the correspondence associated therewith.

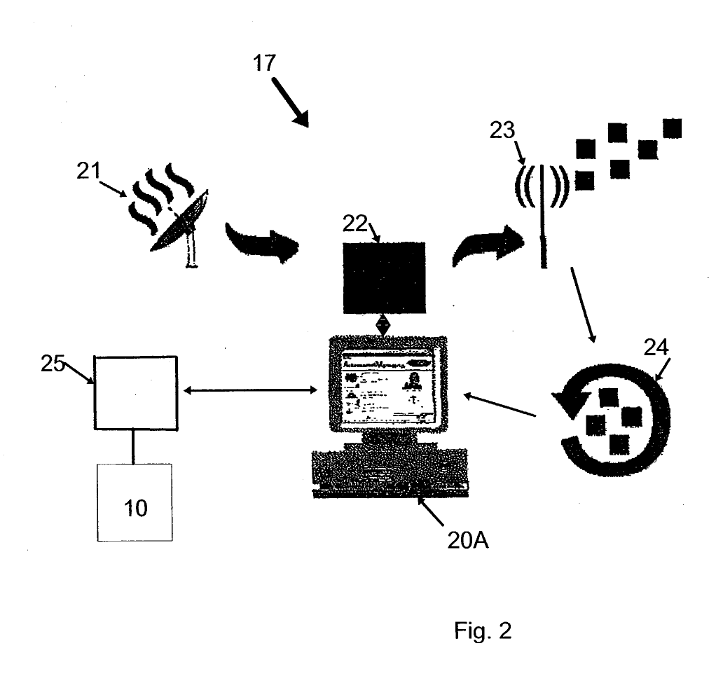

For purposes of this discussion, a “lead” 15 is a potential sales prospect or current customer or client. The lead connects via portal 15a to system 1. As also shown in FIG. 1, in one embodiment a lead 15 can be found through an automated contact collection subsystem 17 that scans a global communications network, e.g., the World Wide Web 18 or a database 19 and identifies potential contacts that fit certain criteria. As shown in FIG. 2, the automated contact collection subsystem 17 is preferably located at a remote sales support center subsystem 20 and consists of an automated contact collector 21 which queries a global communication network 18 for potential leads. A verifier 22 cleans the lead data either manually or automatically through a sales support center workstation 20A. An automated mail broadcaster 23 may then broadcast to the leads. After broadcast, a parser 24 may inspect all returned email/mail and makes additional corrections or changes. Then the revised data is transferred to workstation 20A for review and then to the database 19 for storage and future access. Again, much of this process is preferably automated for ease of use and significant time and resource savings.

In another embodiment, the lead information is gained from an existing user database, e.g., on an electronic database or from a CRM system. A lead may also be provided by the user 10 of said process through direct entry into the inventive system 1 via a mobile marketing module 25A and a user device. Once entered, this data may also be reviewed on workstation 20A and may be “cleaned” by subsystem 17. This is particularly the case if the initial contact with the prospect was made via email, telephone, or an in-person introduction.

Once the database 19 is created or accessed, a mobile marketing module 25A helps the user 10 manage all leads and helps manage remove lists and campaign templates.

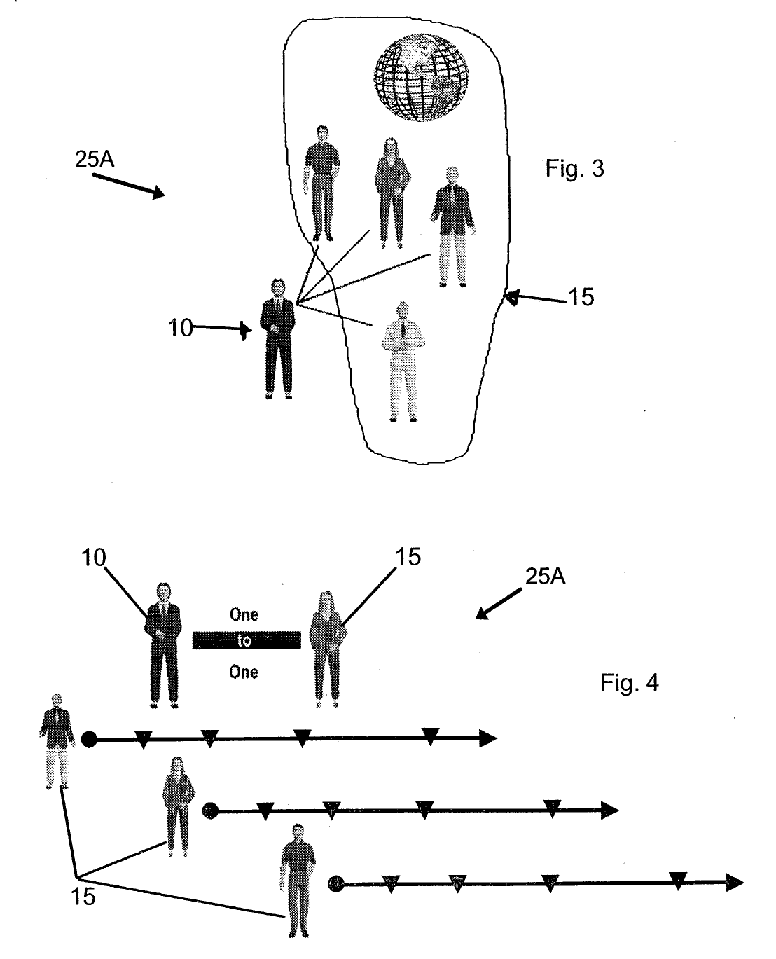

The mobile marketing module 25A is also a business process and software-driven system that involves the use of voice, Internet and wireless network communications services to deliver survey, J2ME, webservices, J2EE, html, dhtml, wap, wml, xml and hwml forms that are used expressly to enter situation specific prospect, customer and trading partner information and trigger certain actions. As illustrated by FIG. 3, the module 25A enables the user 10 to communicate with many prospects 15 located across the globe in a rapid yet personalized and professional fashion. Further as illustrated by FIG. 4, the module 25A allows the user 19 to communicate with multiple prospects 15 on separate timelines in a timely and pertinent manner.

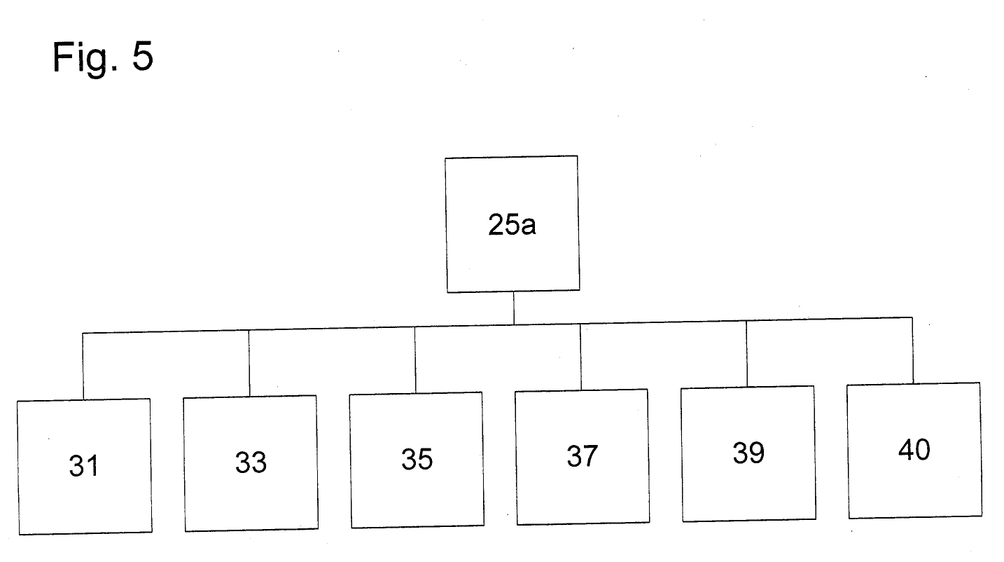

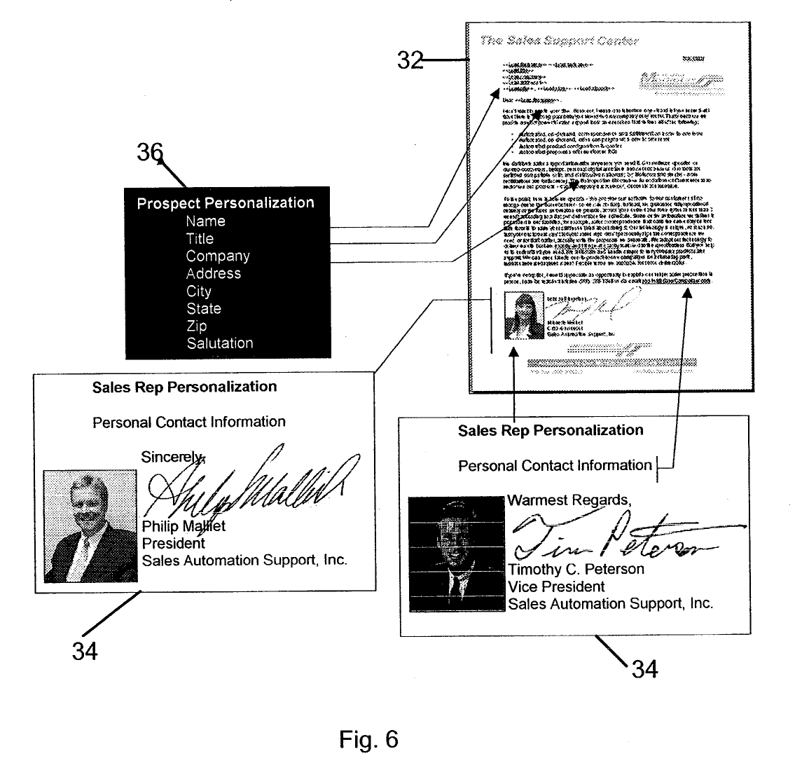

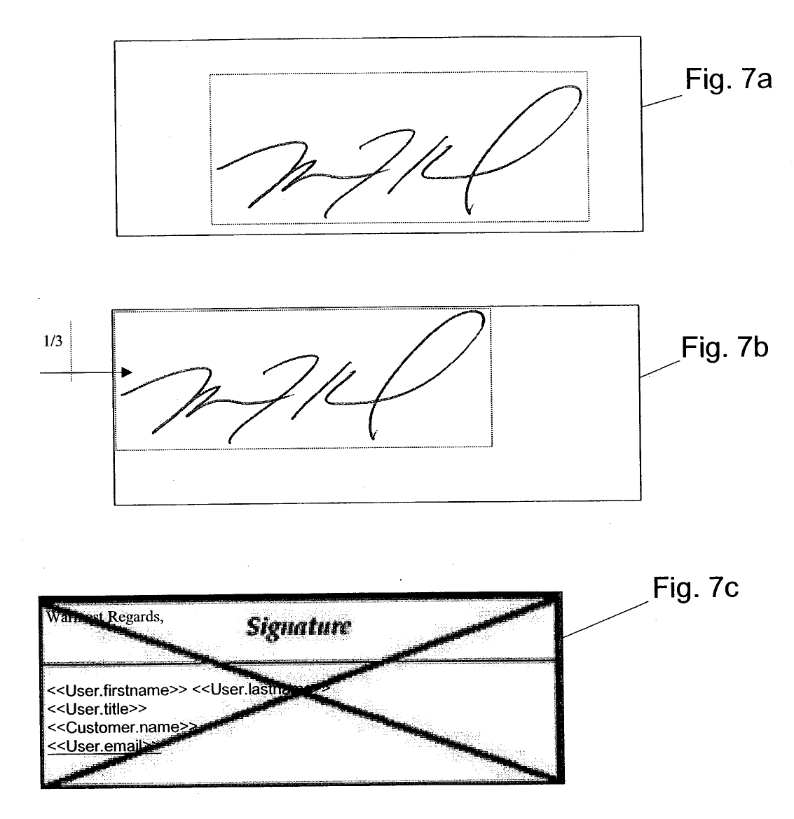

As best illustrated in FIG. 5, the invention uses several key additional processes and apparatus in order to create personal correspondence 32 (see, e.g., FIG. 6) that is indistinguishable from correspondence that may have otherwise been personally prepared by the user of the mobile marketer active lead module 25A. These processes and apparatus are preferably software driven and will be referred to as submodules. In the preferred embodiment shown in the FIG. 5, there are several submodules connected to the mobile marketing module 25A. They include: (a) a global content management submodule 31 that allows any company to fully script and automate personal correspondence for any number of contingency situations which is then generated from a single reference source; (b) a print submodule 40 incorporating a process to customize, on-demand, as a part of the print production process any element of information 34, 36 (see, e.g., FIG. 6) belonging to the target recipient or of the originating user; (c) a signature placement submodule 33 incorporating a process and jig tool 47 whereby each correspondent's signature 34 is stored within a database within an image that represents a referential frame (see, e.g., FIGS. 7a-c). This referential frame is again referenced to a second referential frame. The second frame is stored within a variable template signature block within the body of documents stored within the global content management database. In order to accomplish this, the original signature graphic is scanned with a one to one size relationship to the original. This scan image is then cropped and the resulting image is placed within the boundaries of a larger image, which is also set at an aspect ratio of one to one with respect to the cropped signature image. When the original image is positioned within the larger image, i.e., “the jig,” it is positioned with the topmost portion of the first character in the signature into alignment to an imaginary line starting at a point one-third of the way down the vertical axis of the larger image. This larger image is stored into the system database. To insert and position this image accurately and automatically in unattended fashion into the documents that the system creates, a virtual representation of the larger image is first inserted into the document template and positioned relative to the signature block tags so that the one-third point of the vertical axis of the virtual representation image is in the desired and uniform location where signature will insert. This process has an alternate process, which accomplishes the same result. This alternative process uses an external process to analyze the content of each image file, which identifies the first variation in the file to determine the location where said user's signature begins, this information is transmitted to the print submodule 40 to determine the location where the signature will be inserted into the dynamic document. In this manner, this process allows the print submodule 40 to precisely and automatically place each unique signature into the correct place within each variable document. When printed, it appears to be a natural signature and enabling said personal correspondence to be produced in unattended and fully automated workflow production lines as small as one item of correspondence per order. In some embodiments, additional features include (d) a photo placement submodule 35 incorporating a process whereby each user correspondent's photograph is stored within a database within an image that represents a referential frame (see, e.g., FIG. 6). This referential frame is again referenced to a second referential frame stored within a variable template signature block within the body of documents stored within the global content management database. This process allows the print module 40 to precisely and automatically place each unique photograph into the correct place within each variable document in such a manner that the process of producing the personal correspondence may operate unattended in workflow queues as small as one item of correspondence per order. Finally, the invention may incorporate (e) a data recall submodule 37 whereby data stored within the global content management module 31 automatically populates and generates all of the inventive mobile marketing system's user interfaces on all applicable supported devices; and (f) a printer routing submodule 39 that automatically routes document orders, based on individual mailing locations to the closest company or third party sales support print center for same day production and more rapid delivery. For example, if the lead were in New Jersey and the user California, this submodule 39 would route the print job to a partner or satellite printer center 30a in New York for more rapid printing and delivery.

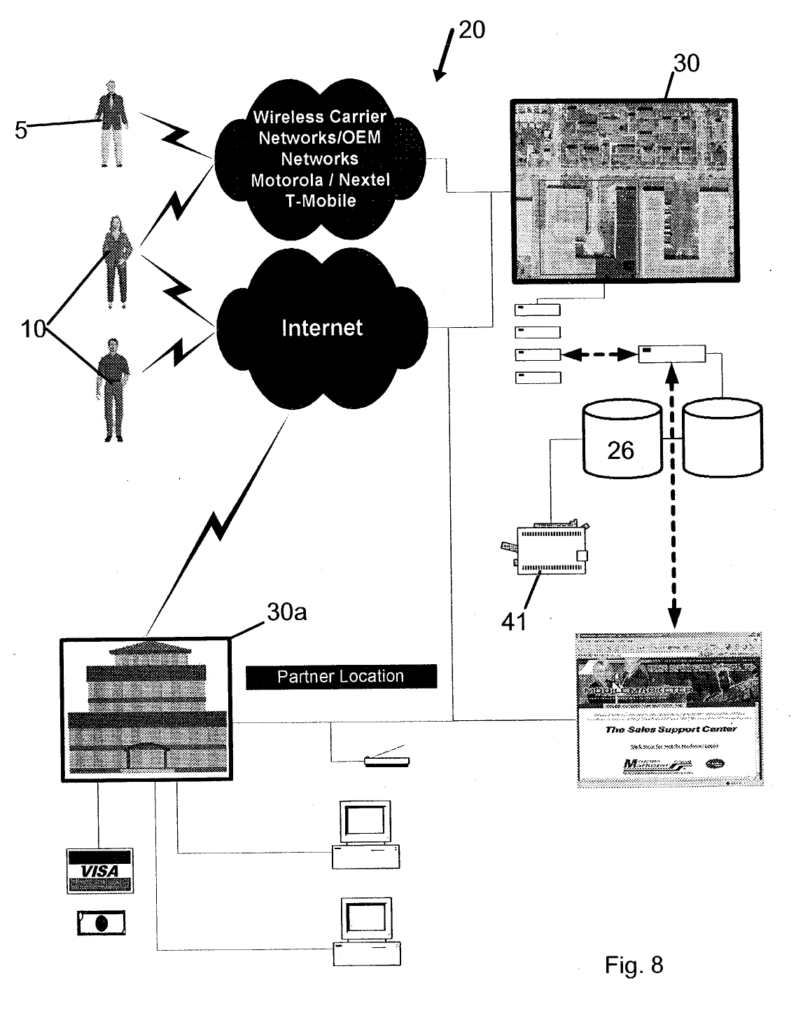

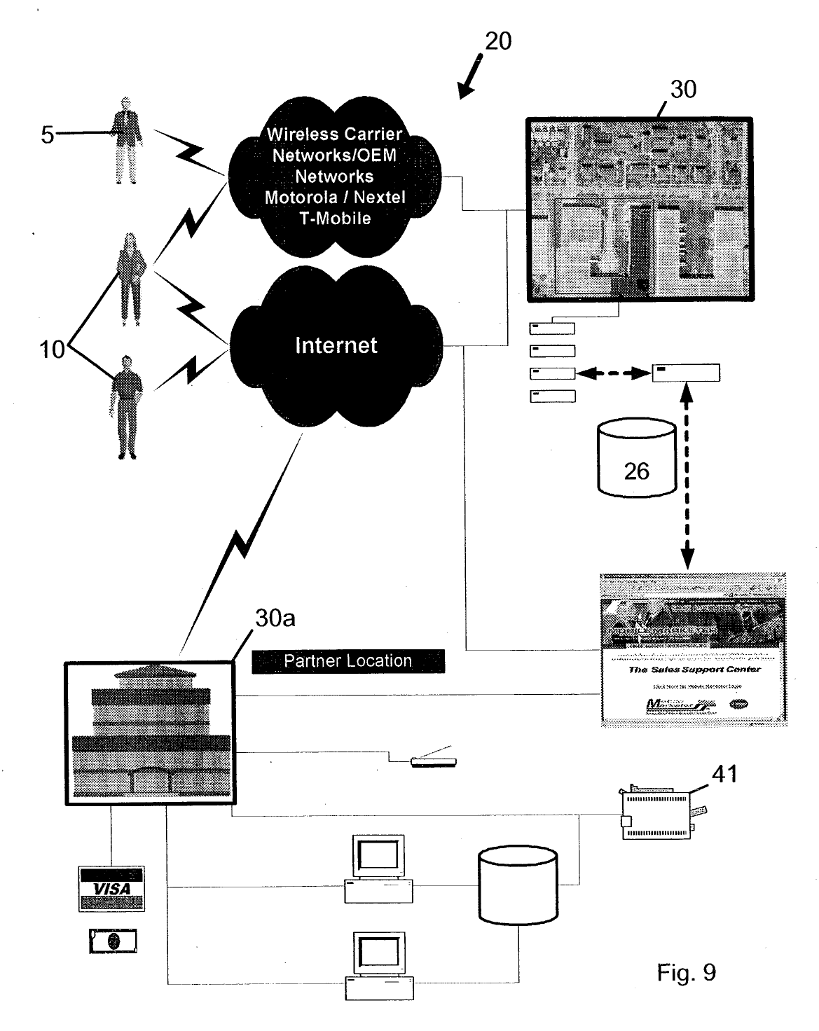

As shown in FIGS. 8 and 9, the module 25A (not shown) preferably links users 10 to a remote service location or sales support center 30 having a support center subsystem 20 which helps carry out these actions. Specifically, the action requests entered by the user via the module 25A result in an order and fulfillment by the center 30 of custom, single unit pieces of personal correspondence and/or responses in electronic and printed formats that are dynamically reassembled from a centralized data repository 26 and that may further reference testimonials or instructions that can be accessed via the Internet, telephone systems and/or through wireless access devices that are in video, audio and printed formats. The submodule 39 may also help the support center subsystem 20 better manage printing resources 41 located at support centers 30 or partner or satellite centers 30a.

As shown in FIGS. 8 and 9, the inventive sales support center subsystem 20, its operational code, methods and/or its workflows may also be used in the following capacities:

To provide on-demand, transaction based correspondence services to system subscriber 5 and users 10 operating from fixed or mobile locations;

To provide on-demand, transaction based data collection and prepossessing services to system subscribers 5 and users 10 operating from fixed or mobile locations.

This support subsystem 20 may be further used:

As the basis of operations for satellite “Sales Support Centers” or partners 30a that will be owned, equipped and operated by the inventor and designated licensees;

As the basis of operations for satellite “Sales Support Centers” 30a that will be designed, installed, operated and managed by the inventor directly on behalf of contracting organizations and corporations for private use;

As the basis of operations for satellite “Sales Support Centers” 30a that will be designed, installed, operated and managed by licensed and authorized third parties directly on behalf of contracting organizations and corporations for private use;

As the basis of operations for satellite “Sales Support Centers” 30a that will be designed, installed and supported by the inventor and operated and managed by contracting organizations and corporations for private use; and

As the basis of operations for satellite “Sales Support Centers” 30a that will be designed, installed and supported by the inventor's licensees and operated and managed by the licensee's contracting organizations and corporations for private use.

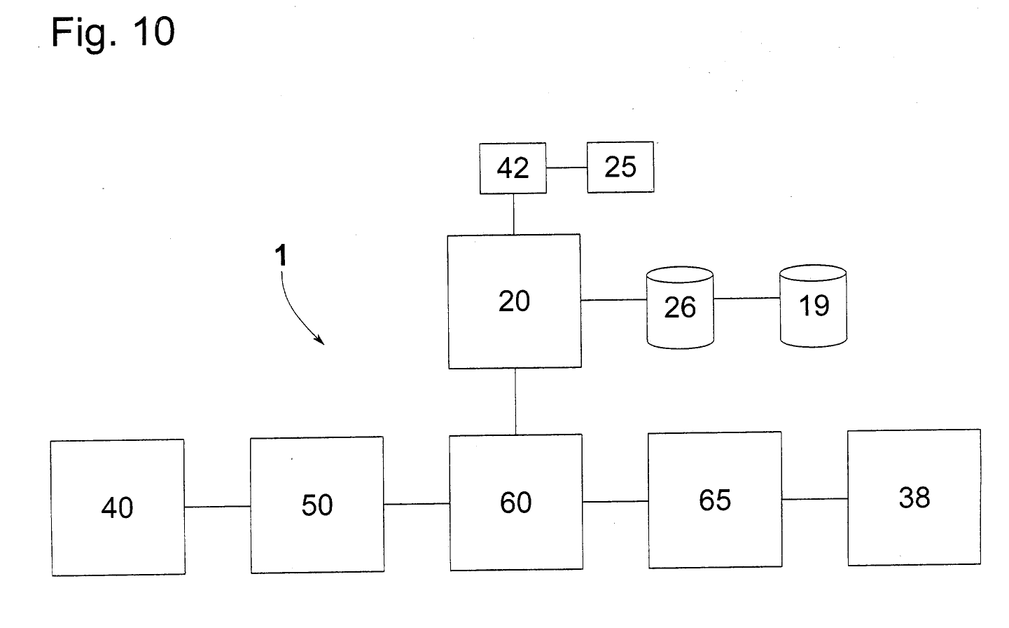

Further, additional and related information captured during the order process is securely retained within data repository 26 of the support center subsystem 20 at the sales support center 30 and then re-distributed for import into any information system or device operated by the user 10 on request. Also, during the order process, the system can assign users to an automated “program” for the fulfillment of subsequent and “pre-timed” personal “communications events.” As shown in FIG. 10, this is handled through a scheduling module 38 which interfaces with the marketing module 25A. The communications events consist of the dynamic assembly, printing, electronic delivery functions, enveloping, and mailing services that are provided through print module 40 operated through the remote sales support center 30 equipped for this function. The print module 40 may drive multiple printers 41 as shown in FIGS. 8 and 9. Personalized and situation specific marketing and sales correspondence items are produced and mailed the same day the online form or call request is completed by the system user or on the “pre-timed” day the automated responses are scheduled.

Specific personalized correspondence 32 in database 19 within data repository 26 includes the following dynamically reassembled and printed or transmitted document types:

| | |
|---|---|
| Sales Letters | Meeting Requests |
| Action Reports | Quotes |
| Proposals | Contracts |
| Return on Investment Analysis Reports | Greeting Cards |
| Invitations | Legal Documents and Pleadings |

Specific elements of information that are captured as a by-product of the order process and that are processed and retained for redistribution back to the users' personal or corporate information systems include:

Prospect Data (Name, Title, Company, Address, Phone, Email, Fax, and Preferences, e.g., saved by Key Word Indexing), and a market category classification as dynamically designated by the user for tracking and sorting purposes:

Sales Forecasts and Updates

Expense Report Items

Automated Correspondence Program Assignments

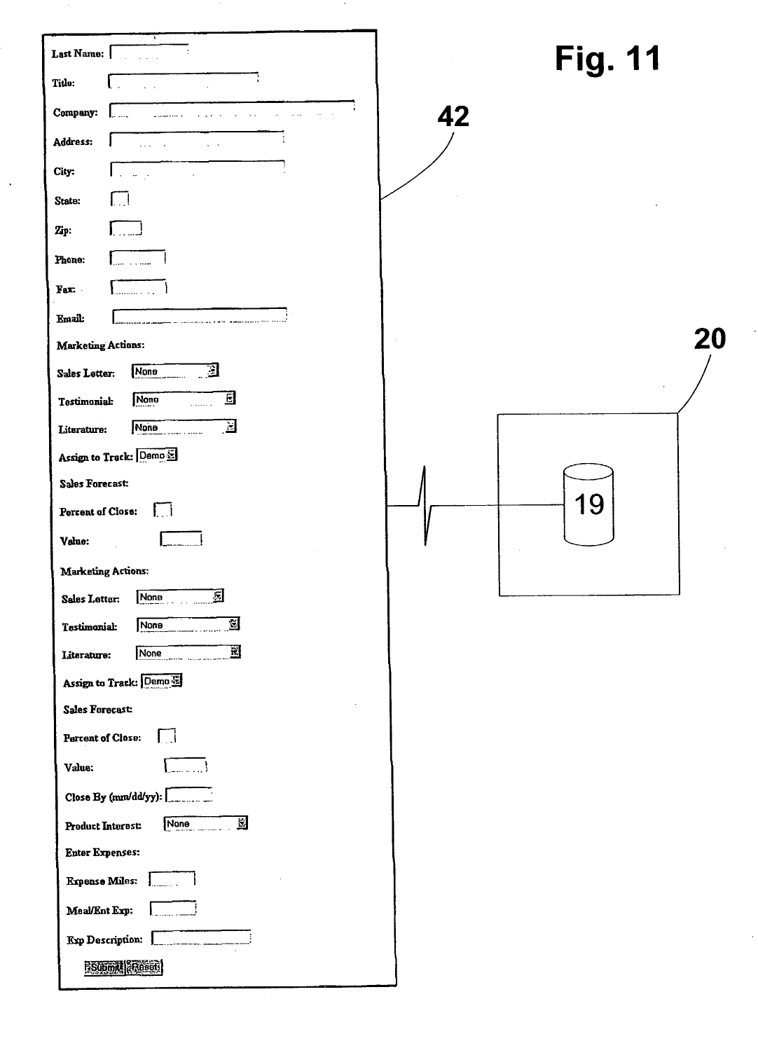

As shown best in FIG. 11, key elements of data with respect to prospects, forecasts, expenses, and follow-up scheduling may be collected independently of the users' physical and logical information systems infrastructure and displayed through a unified form which is delivered via Internet and wireless data communications services. This will be further referred to as a prospect data collection interface 42.

Collected information captured by this prospect data collection interface 42 of system is stored by subsystem 20 at database 19. It is used automatically and immediately to generate personalized situation specific communications, usually in the form of correspondence, directed to the prospect that are fulfilled and handled by the subscriber's assigned remote sales support center 30. The user is not required to handle or directly interact with the correspondence. Thus, this represents a unique process not normally associated previously with the act of collecting prospect information. Data collection interface 42 preferably captures contact data information for the active lead prospect, such as last name, title, company name, address, city, zip code, phone, fax no., email address. It also collects marketing action information, such as letter election data, testimonial references, literature requests; and automated marketing data, such as tracking assignment information, sales forecast data and expense report data. The sales forecast information captured consists of percent of close and the total value of the perspective deal. Additional information collected is a close-by date (mm/dd/yy), specific product of interest, and expense data, including expense miles, meals and entertainment expenses, and other expense descriptions. A submit and reset button allows the user to either submit the data to the central database 19 located at preferably the service support center subsystem 20 or to reconfigure and reset the page to enter new information. The collected information from these data fields may used to drive actions in other related submodules that are part of the system. Such submodules will be discussed more completely below.

Communications that are automatically prepared for the subscriber by the sales support center subsystem 20 using this information may reference, as a postscript entry (e.g.—P.S.), an “Active Lead” testimonial that may be later delivered via one of two methods that are selected by the subscriber—an “Active Lead” Internet delivery or “Active Lead” voice mail delivery.

Specific embodiments of the present invention will now be further described by the following, non-limiting examples which will serve to illustrate various features of significance. The examples are intended merely to facilitate an understanding of ways in which the present invention may be practiced and to further enable those of skill in the art to practice the present invention. Accordingly, the examples should not be construed as limiting the scope of the present invention. Moreover, there are virtually innumerable uses for the present invention, all of which need not be detailed here. All the disclosed embodiments can be practiced without undue experimentation.

### Example 1

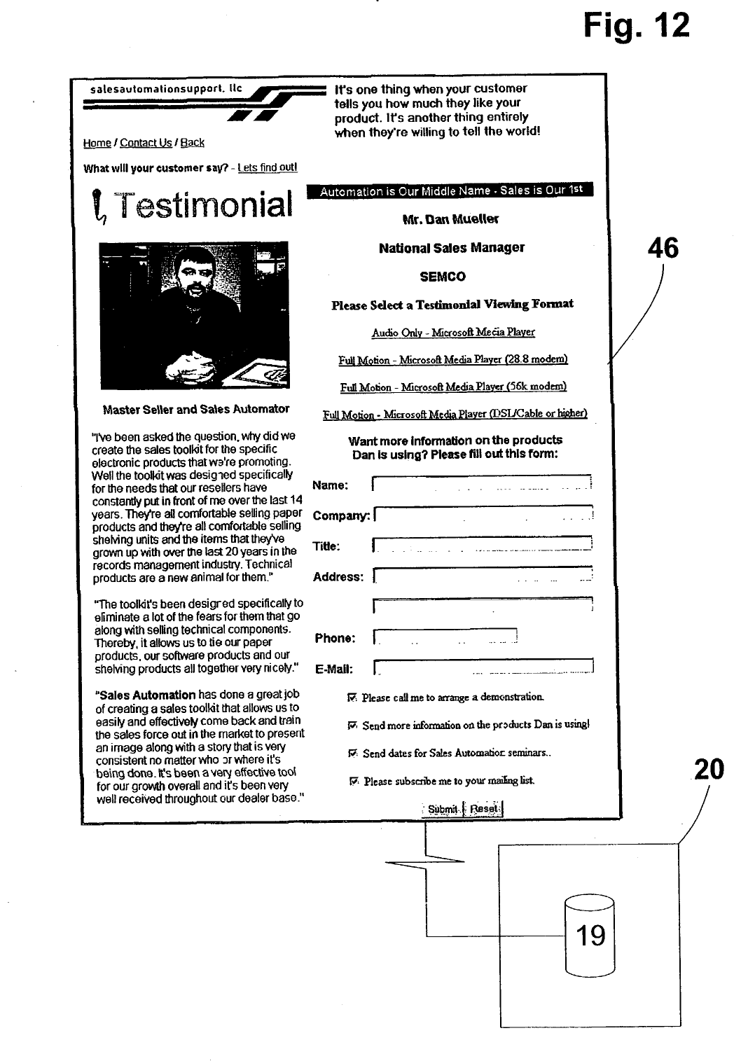

The Internet can be also used to deliver a message of the system 1 to an “Active Lead.” This message or correspondence (see, e.g., FIG. 6) typically references a web page based testimonial that is physically hosted by the sales support center. The format for the “Active Lead” testimonial correspondence shown in FIG. 12 preferably combines all of the following elements into one viewing window:

The subscribing company's logo,

An eye-catching statement like “It's one thing when your customer tells you how much they like your product or services. It's another thing entirely when they're willing to tell the world,”

A graphic element that conveys the meaning “Testimonial,”

A picture of the testimonial giver and a listing of the testimonial giver's name, position, company, and geographic location,

A summarized description of which of the Subscriber's products or services the testimonial giver uses,

A text transcript of the testimonial giver's testimonial,

The ability to listen to a streaming audio file of the testimonial giver's testimonial,

The ability to view a streaming video file of the testimonial giver's testimonial, and

As shown in FIG. 12, therefore, one goal of the above-identified testimonial reference preferably is an active lead testimonial page 46 that consolidates and presents to a viewer the pertinent testimonial information with regards to, for example, a specific subscriber and/or sales rep. Further the audio only or video and audio replay is preferably done via a program such as Microsoft Media Player. This may be presented through DSL cable, 56k modem, or 28.8k modem or any higher speed connection. Additionally, a form for follow-up prompts the viewer to check boxes to arrange for: calling the viewer to arrange for a demonstration, sending the viewer additional information on the products used by the company showcased in the testimonial, information regarding upcoming seminars, and the ability to subscribe to the subscriber's mailing list. Viewer contact infonmation is also requested. There may also be buttons to subscribe or reset the viewer's information fields. The page 46 may also contain links to the subscriber's website page, email, other contact information, or additional marketing materials.

The data collected from the testimonial page 46 is stored in database 19 in the repository 26 (not shown) at the sales support center 30 (not shown) within subsystem 20 for possible electronic delivery and import into the subscriber's physical and logical information systems on request or at preset times defined by the subscriber.

The “Active Lead” web page 46 represents an integrated and automated form that allows the testimonial viewer to enter information and request additional follow up actions, literature or materials. Entries from this form are submitted either to the subscriber via electronic or printed means or are fulfilled by the remote sales support center.

Based on subscriber preferences, the testimonial may also contain a hypertext link to an online form that allows the prospect to enter information used to dynamically calculate a return on investment (ROI) analysis for the prospect's specific situation.

As can be seen, FIG. 10 provides a general overview of the modules which interface with the support center subsystem 20.

In one embodiment, there may also be prospect ROI information available to the subscriber and the user.

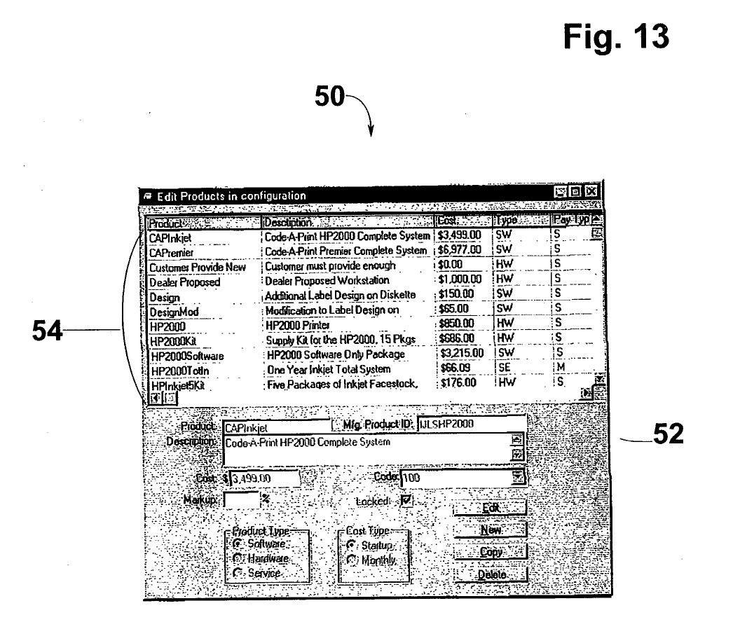

As best shown in FIG. 13, a configuration components data management or quote submodule 50 is best illustrated through the web page portal 52 shown. The submodule 50 is accessed by the subscriber from their site and is used to update a configuration parts master data form 54 for automated quote, proposal and assembly orders via the mobile marketing module 25A. The information displayed on this page may include product information, product description information, costs, type, pay type, etc. Other information may include manufacturer's product identification, costing codes, mark-up percentages, costing type information such as start-up or monthly billing, and a product category type (e.g., software, hardware, or service). Buttons may also be available on this page for editing, entering new information, copying the displayed information to another file or deleting the same. Once the fields are populated, this information can be transferred to the print submodule 40 for order fulfillment.

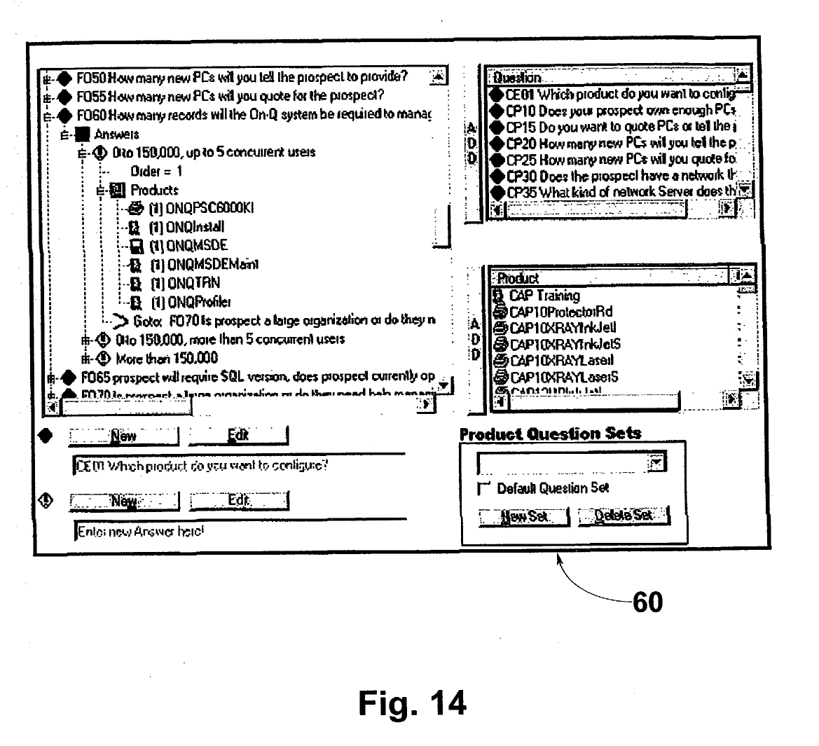

A configuration logic engine submodule 60 is best illustrated at FIG. 14. This submodule 60 is also preferably operated at the subscriber's site and is used to update configuration relationships between the parts master form 54 and logical, situational specific questions 62 related to the selling situation. This info is also used during the automated quote, proposal and contract assembly, and orders processing via the mobile marketer active lead module 25A. The configuration logic engine submodule 60 typically consists of a series of questions 62 that allow the active subscriber sales employee, i.e., the user, to think through the business contact and turn it into an active sales lead. Questions may consist of how many new products the prospect is interested in, how many used products? How many will be quoted? What is the number of total users of this product within the prospect's organization? Is there any discounting available relative to the same? Etc. These questions are usually formulated by the subscriber's sales marketing director relative to a specific sales campaign, product offering, and/or sales cycle.

### Example 2

The correspondence may also be delivered via voice mail to an “Active Lead.” First, the system references a telephone number and voice mail box that is operated by the remote sales support center 30 which can be contacted to play the sales testimonial. The format for the “Active Lead” voice mail testimonial includes:

An audio recording upon entry that announces something attention grabbing like: “It's one thing when your customer tells you how much they like your product or services. It's another thing entirely when they're willing to tell the world,”

An audio recording of the testimonial giver's name, position, company, geographic location and the testimonial giver's testimonial, and

A series of integrated menu and voice/keypad input prompts that allows the testimonial listener to enter information and request additional follow up actions, literature or materials.

Entries from this form are submitted either to the subscriber via electronic or printed means or are fulfilled by the remote sales support center.

Lastly, based on subscriber preferences, prompts are also served that route the listener to an online touch pad query that allows the prospect to enter information used to dynamically calculate a return on investment (ROI) analysis for his/her specific situation.

After the “Active Lead” has been contacted via the Internet or voice mail, a piece of follow-up correspondence (see, e.g., FIG. 6) may be generated. When traditional written correspondence is requested, an imaged, enhanced and authorized signature for the user is then preferably called up from a database and automatically merged into a dynamically reassembled physical letter, memo, document or electronic message for printing or transmittal. This occurs at the sales support center 30.

As indicated, the sales support center 30 may also prepare written quotes, proposals, contracts and legal documents. This is accomplished again preferably through the use of at least one unified form that interfaces with the quote submodule 50 shown in FIG. 13. The quote submodule 50 presents through the interface form to the user questions and suggested answers that correspond to anticipated environmental situations that the subscriber can pre-identify with respect to its targeted prospect. Data captured related to these questions is interpreted according to a set of business rules that the subscriber defines and is matched to a repository database of parts data, price data, configuration data, and text descriptions and images. Data is preferably stored in the centralized repository 26 managed by the subscriber's remote sales support center 30. The data relationships and configurations are managed and controlled through the quote or configuration components data management or quote submodule 50, and the configuration logic engine submodule 60.

The sales support center 30 also prepares models and reports for Return on Investment (ROI) analyses that are specific to the “sale situation” that the subscriber has identified. This is preferably accomplished again through the use of a unified form that presents questions that correspond to actual environmental situations that the subscriber can identify with respect to their target prospect. Data captured related to these questions is calculated according to a set of business rules and a return on investment (ROI) calculation model that the subscriber defines and is keyed to specific part or “concept” data housed in the centralized repository and as setup using the configuration components data management Form (above). Return on Investment (ROI) data and descriptive text is preferably stored in the centralized repository 26 managed by the subscriber's remote sales support center and data relationships and configurations are managed and controlled through the use of ROI engine configuration submodule 65.

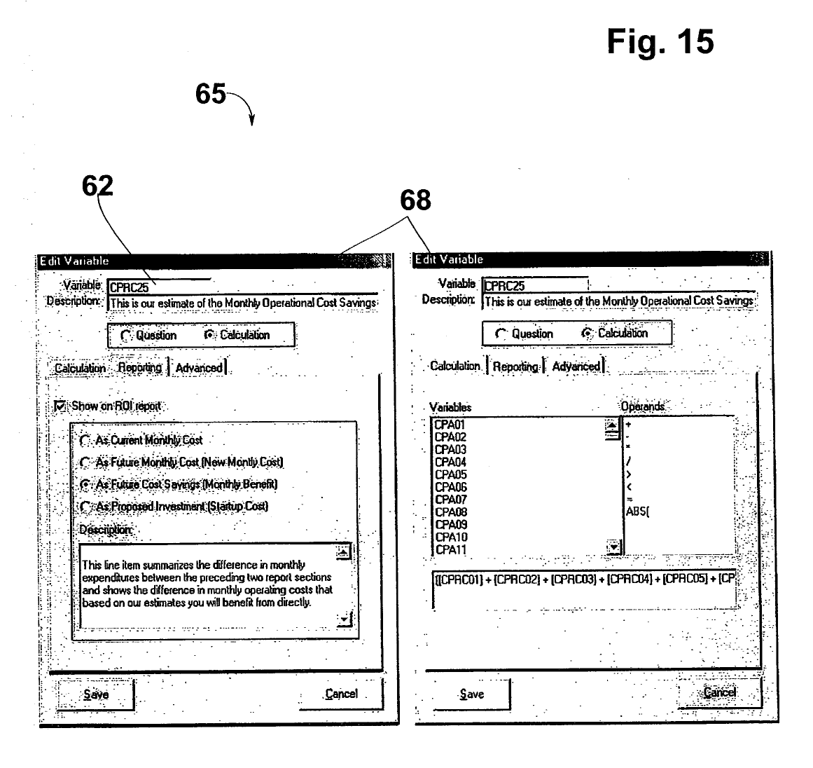

The ROI engine configuration submodule 65 interface 68 shown in FIG. 15 is preferably accessed at the subscriber's site and is used to update return on investment analysis models between the parts master form and logical values delivered by linked products based on specific situations. The submodule 65 is invoked automatically by the automated quote proposal and contract assembly submodule 50 via the mobile marketing module 25A. The submodule 65 typically allows the user to populate fields relative to product description, cost calculations based on current monthly costs, future monthly costs, future cost savings, and as proposed investment/start-up costs. There is also a line which allows for further description of the report and/or transaction. There is a “save” button and a “cancel” button also included. Variables can be selected from a calculation tab and a report can be generated. There is also an “advance” tab which allows for further data input and calculation.

It should be noted that configuration and data entry forms mentioned above are interacted with in either of the following ways:

From the subscriber's primary business location, where data is entered, configured and managed, then uploaded to the remote sales support center repository,

By the subscriber at place in the field, or

By the remote sales support center personnel on behalf of the subscriber.

Interpreted relationships between parts, price, quantity and situational relativity data are preferably linked between the configuration components data management submodule 50, configuration logic engine submodule 60, and ROI engine configuration submodule 65 through the use of a unique “code assignment” relationship. This code 66, called the ROI code is not restricted for use singularly by item, rather it can be assigned by the subscriber to multiple physical or logical concept items and is a code that represents a logical thought with respect to the ability of the “item” to respond effectively to a particular environmental situation.

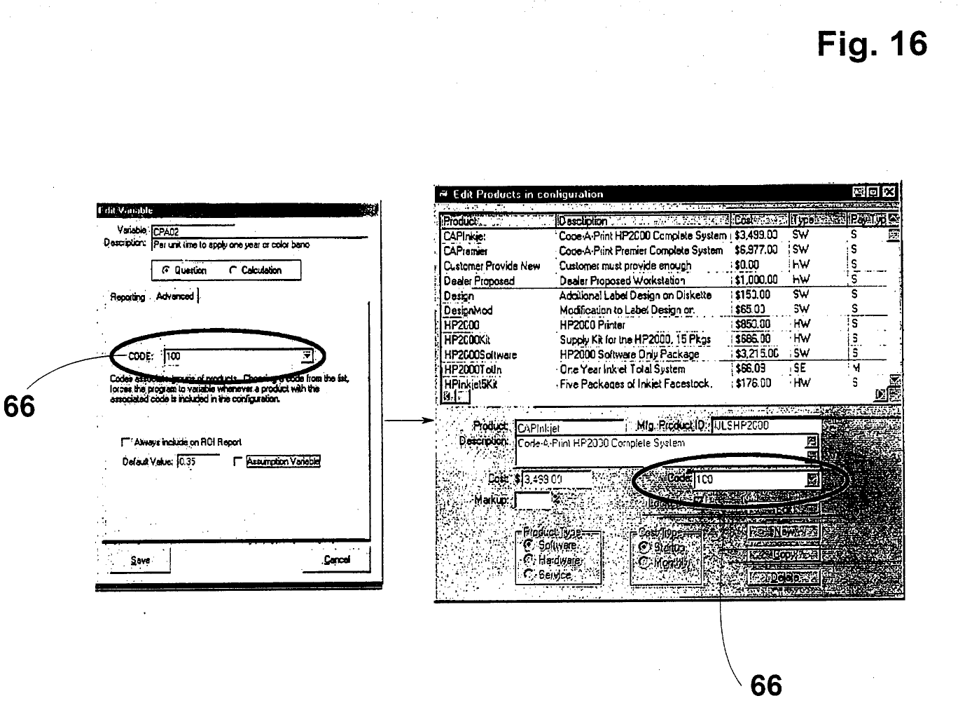

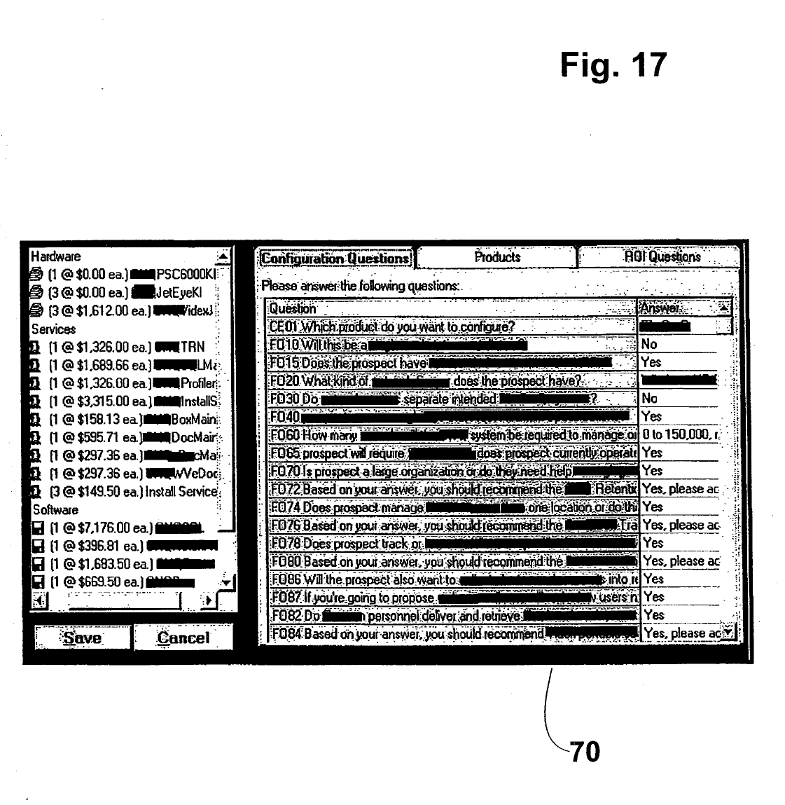

As shown in FIG. 16, two web page interfaces are shown to illustrate the unified ROI code 66. The code is associated in either a one-to-one or one-to-many relationship in correspondence with the parts entered on the configuration components data management submodule 50. This information is linked via the ROI engine configuration submodule 65. The presence of this code within a completed configuration triggers processing of linked ROI analysis models during the automated document assembly process used by the mobile marketer active lead module 25A. Information relevant to the assembly of the dynamic document and to the resulting ROI computation is gathered through a variable user interface that changes based on the items included with each respective configuration. This information is determined by the system through an automated process which analyzes the configuration list (FIG. 17) and matches it to ROI codes that are a part of each “Part Item” record. These ROI codes are also indexed to a table through a simple forms based administration interface that contains selections to predefine entries that correspond to four types of global system variables; ROI assumption variables (FIG. 16), ROI question variables (FIG. 16), ROI calculation variables (FIG. 15), and ROI report output variables (FIG. 15). The user interface for creating an ROI report is then generated based on the indexed variables that correspond with Part Item records selected for the configuration using the natural language configuration scripts (FIG. 17). Entries provided in response to ROI question variables complete the dataset and when the user selects a command to produce the document, the system calculates the results and merges the results along with the ROI report output variables (descriptions of the calculations) to which they are associated into predefined sections of the dynamic document.

Instead of user interface 42 shown in FIG. 12, the user may also interact with mobile marketer module's natural language prompt interface 70 through either remote client, web page or wireless device interface. FIG. 17 illustrates the mobile marketing module natural language prompt interface 70. As best shown in FIG. 18, the interface 70 information is delivered to the user in several different modes depending on their method of conductivity. For example, for WAP in cellular applications 71, the interface is omitted and only the questions appear on the device. This presents the flow of questions mapped by the configuration logic engine module 60 (shown in FIG. 14) and run-time questions linked to the ROI codes from the resulting configuration (see FIGS. 15 and 16) when the user connects to the mobile marketer active lead module 25A to process requests for quotes, proposals, contracts or return on investment analysis. Configuration questions include information related to specific products and services. Answers usually include a “yes” or a “no” answer. All answers and data inputted into the fields can be either saved or canceled. Cost information is also collected.

The resulting dynamically prepared documents are usually then:

Transmitted by the sales support center electronically to the destination the user specified,

Printed and mailed by the sales support center to the destination the user specified,

Orders for documents are fulfilled singularly and on the day they are received, and

Orders are entered by system users through a set of secure and proprietary interactive forms that are delivered, based on the users communications capabilities through the following formats: Call in survey, or Internet and/or wireless access forms, independent of and including but not limited to forms based on specifications of; html, dhtml, shtml, wap, wml, hwml and xml.

As shown in FIG. 19, the typical system 1 configuration for the subsystem 13 comprises devices used to access online forms through a system gateway 14 (e.g., an ISP or VPN) connected to server computer located with the support center subsystem 20 via an Internet 18. The devices 13 include but are not limited to:

| | |
|---|---|
| Personal computers | Handheld computers |
| Wireless access devices | Mobile phones |
| Laptop computers | ATM machines |
| Access enabled radios | Televisions |
| Multimedia/broadband set top devices | |

While similar equipment may be used by the subscriber subsystem 12, the likely equipment configuration is shown.

Information captured as a by-product of correspondence orders is also processed and returned to the user or user's organization (i.e., the subscriber) for ready import into any existing information system.

3. In Use and Operation

The specific workflow model ascribed to the inventive business system and process above is detailed as follows using an example of an individual sales representative in the field:

A. Subscriber Situational Interaction

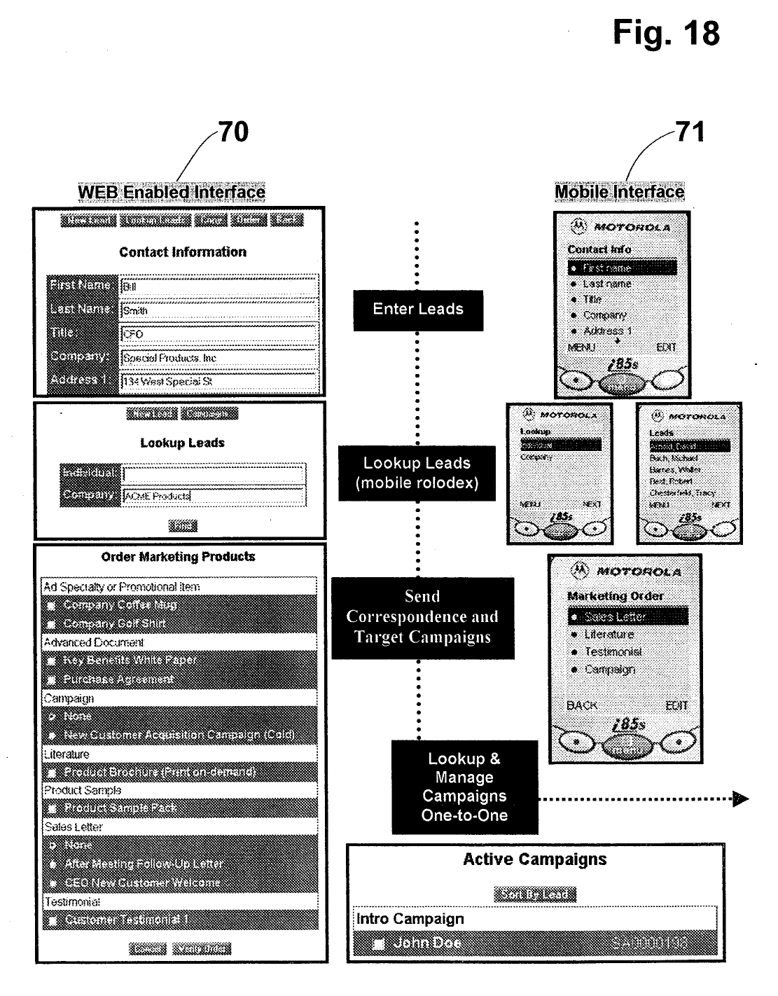

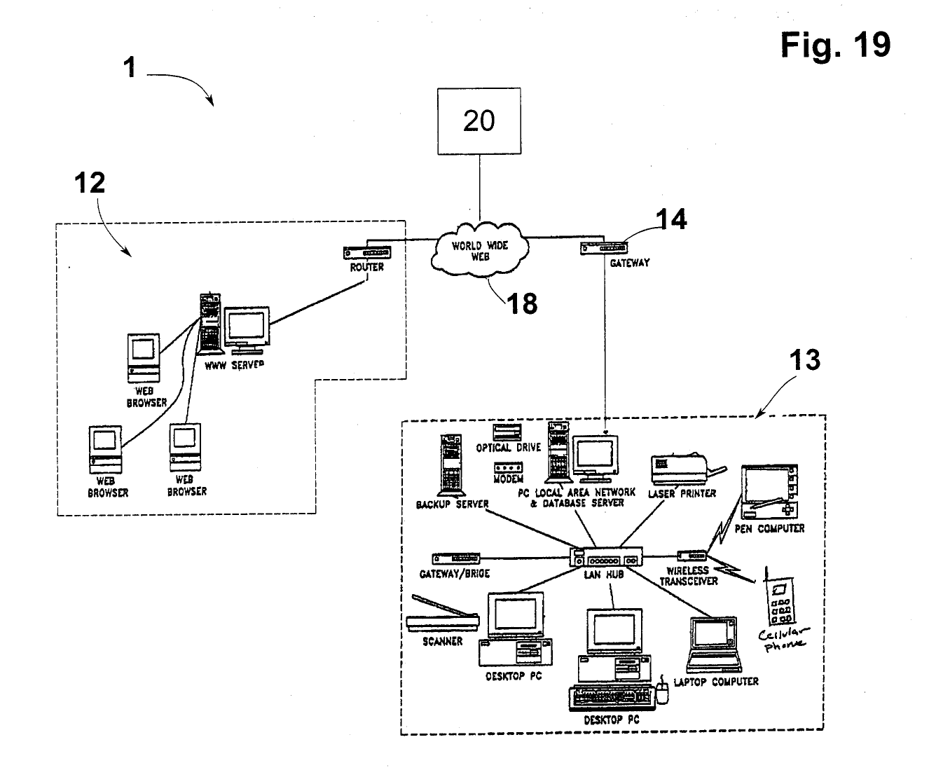

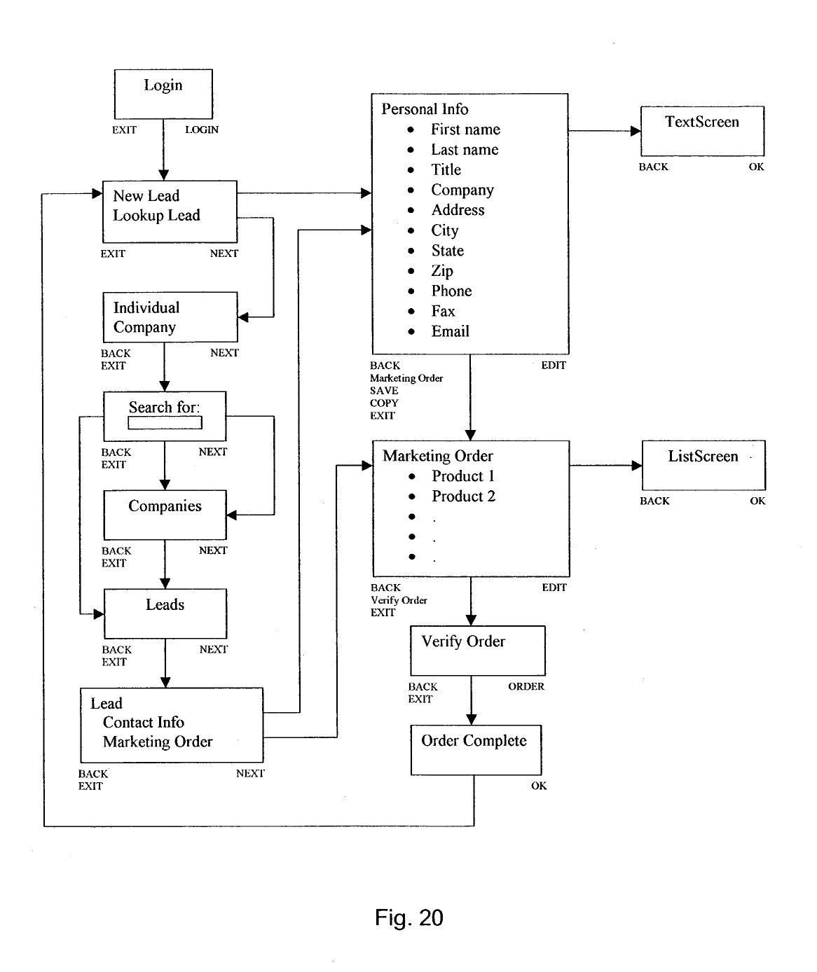

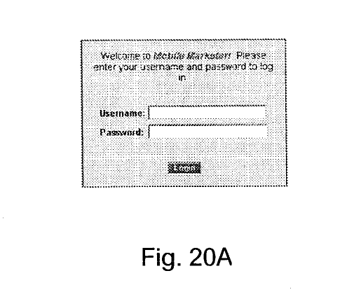

As best shown in FIG. 20, when a user meets a prospect via telephone, correspondence, or in person, the user logs onto the private mobile marketer system and preferably while using a user name and pass word interface (see FIG. 20A) selects a “new lead” form. The user enters the prospect's data, including his or her name, title, company, address, city, state, zip code, phone numbers, email address, etc. Alternatively, the user can query the database if the prospect has been previously and recall their contact data. The user then selects the appropriate sales letter/communication for the situation and selects the appropriate “active lead” testimonial and method of delivery for the situation. The user may select a continuous marketing track as desired for the particular Prospect and may select different options for automated correspondence fulfillment, such as Christmas card delivery. The user may additionally enter sales forecast information to be linked with the prospect information, such as the probability of a sale, amount expected, closure date, product class interests, etc. Finally, the user may enter expense data associated with the prospect, including mileage, meals, entertainment, and descriptions for each expense.

Each of the entries made by the user is entered either through a form, in the case of data transmitted via the Internet, or, when the order is made via telephone call, in response to queries. At each step, the sales support center captures the data and stores it in a centralized database. The sales support center also automatically schedules and routes production of the selected “active lead” testimonials, the continuous marketing track, and the greeting card delivery options. When the user logs off the system, the subscriber session is closed.

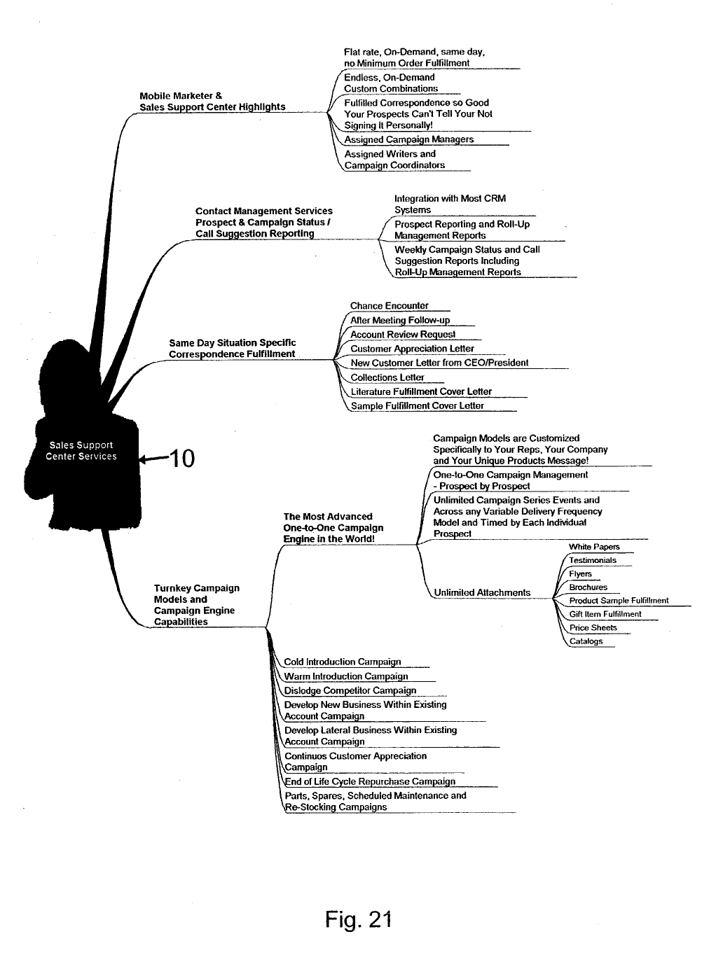

As shown in FIG. 21, when the user 10 connects to the support center 30 (not shown), almost any type of campaign is possible, here are examples of types:

Warm Introduction Campaign—Used after meeting someone briefly that is a good prospect. The campaign, depending on the type of the user's product or service has a variable frequency and duration lasting between two months to two years and generally consists of 3 to 5 personal communications, accompanied by literature and or testimonials. Each communication reinforces the user's value proposition and requests an opportunity to meet and do business.

Cold Introduction Campaign—Used to automatically target someone that is a good prospect. The campaign, depending on the type of product or service has a variable frequency and duration lasting between two months to two years and generally consists of 3 to 5 personal communications accompanied by literature and or testimonials. Each communication reinforces the user's value proposition and requests an opportunity to meet and do business.

Dislodge Competitor Campaign—Used to automatically target someone that known to be doing business with a competitor. The campaign, depending on the type of product or service has a variable frequency and duration lasting between two months to 6 months and generally consists of 3 to 5 personal communications accompanied by literature and testimonials. Each reinforces the user's value proposition and suggests that user can deliver better product, price, or results then suggests that exploring the possibilities of alternate relationships is always beneficial and consistently requests an opportunity to meet.

Develop New Business within Existing Account Campaign—Used to automatically target user current buyer/customer within an account. This campaign introduces new products, services, capabilities or ideas. The campaign, depending on the type of product or service has a variable frequency and duration lasting between two weeks to 2 months and generally consists of 2 to 4 communications accompanied by literature and testimonials.

Each presents a good reason to get together and or explore new possibilities—highly effective.

Develop Lateral Business within Existing Account Campaign—Used to automatically target someone in an existing account that user does not directly do business with. This campaign is applicable to selling within large accounts where introductions and opportunities within other divisions or departments are possible. The campaign, depending on the type of product or service sold has a variable frequency and duration lasting between two months to 6 months and generally consists of 3 to 5 personal communications, accompanied by literature and or testimonials. Each communication reinforces user's value proposition and current successes within the business using the other buyer as the example and suggests that the current prospect would also benefit from the same type of relationship and consistently requests an opportunity to meet and do business.

Customer Continuous Appreciation or Image Building Campaign—This campaign is used to ensure that customer never feels forgotten. The campaign, depending on the type of product or service sold, and depending on the customer's typical versus desired purchasing habits has a frequency that conforms to a schedule of monthly, quarterly or semi-annual contacts. This campaign can also be used to inform. This campaign runs continuously.

End of Life Cycle Repurchase Campaign—This campaign targets existing customers and the know end of life for the product or service they purchased. Based on product or service, this campaign targets the customer from as soon as three months before end of life to as close to one week before EOL. The campaign consists of two to three correspondences. It is ideal for end of lease call to action.

Parts, Spares, Scheduled Maintenance and Re-Stocking Campaigns—This campaign is modeled to conform to the preventative and recurring maintenance cycles for consumables and parts for products that the customer operates. Additionally, this campaign is also used to boost your customer's investment in spares of the same nature. This campaign's correspondence and frequencies are based on your specific product.

Event Promotion Campaign—This campaign is modeled to count down to a specific event or sale and is designed as a personal invitation. Depending on the event or scope of sale, several communications are sent at prearranged dates prior to the event.

The Team Selling Campaign—Use the system's features to launch team selling campaigns. Mix different campaign types personalized from different individuals on the selling team and direct them to the same prospect at the same time, one after the other, or combined into coordinated offset time lines.

Also shown by FIG. 21, the correspondence options may consist of:

Chance Encounter Letter—Used after meeting someone briefly that users think will be a good prospect. The letter acknowledges the introduction, provides an overview of user's value proposition and asks for an opportunity to get together;

After Meeting Follow-Up—Used to reinforce the prospect's opinion of user's professionalism. The letter thanks the prospect for taking the time to meet, reinforces the value proposition, assumes the business and suggests next action.

Account Review—Used to schedule periodic account review meetings. Thanks the customer for his/her loyalty to user's company, offers services to discuss their needs and ensure product or service is meeting demands—suggests a meeting soon and provides the next action.

Customer Appreciation Letter—Used to reinforce the relationship by thanking the customer for a recent purchase and offers user's personal attention anytime. Then suggests that if the customer was indeed happy with product or performance that they refer user to others.

New Customer Letter from President/CEO—Generated anytime you acquire a new customer and personalized from the President or CEO. No company is too big and no CEO too high up on the ladder not to make this one of their standard customer relationship practices!

Sample Request or Literature Cover Letter—Used to accompany samples or literature fulfilled by the Sales Support Center. Personalized one-to-one so that it appears the literature or sample was personally prepared and mailed by user.

Cross Referral Letter—Thanks the customer for their loyalty while asking if they know others who will also benefit from your product or service. This is a more specific referral gathering variation of the customer appreciation format.

Special Event or Sale Announcement—Get the word out quickly on just about any event, sale or special appreciation function. Alternatively, turn this into a campaign and mail on a count down frequency right up to the event!

The Collection Letter—A company's services and products are valuable. As such, everyone deserves to be paid! This correspondence reminds customer of this gently, sternly, or in a full force onslaught.

As also shown in FIG. 21, the system allows the support center subsystem to characterize and access various attachment types by function. These attachments may also be sent to prospects independently through independent fulfillment requests. Typical on-demand or stock attachments and fulfillments include:

On-Demand White Papers—used to educate prospects, a white paper or case study becomes an invaluable tool to accomplish this. Support includes on-demand printing, binding and fulfillment;

Catalogs—product catalogs fulfillment includes helping to design, layout and publish for on-demand printing or traditional print production and stocking;

Product Price and Data Sheets—may be stocked or printed on demand and may include any related situational or campaign correspondence item;

Brochures & Flyers may be stocked or printed on-demand for tri-fold brochures and flyers.

Testimonials—often used to really set a subscriber apart, on-demand printing and fulfillment of a single page, full color testimonial can add power to a traditional sales pitch. The correspondence, may also reference online streaming video testimonials at the same time!

Product Samples—product samples may be fulfilled the same day or may be included as a part of any ongoing campaign. Pricing and arrangements typically depend on sample type, size and weight and perishability, e.g., foodstuffs.

Promotional or Gift Items—this feature also the sales force to stop driving around with all of those coffee mugs, pens, paper weights and polo shirts in their cars. The support center can fulfill them with a personal note.

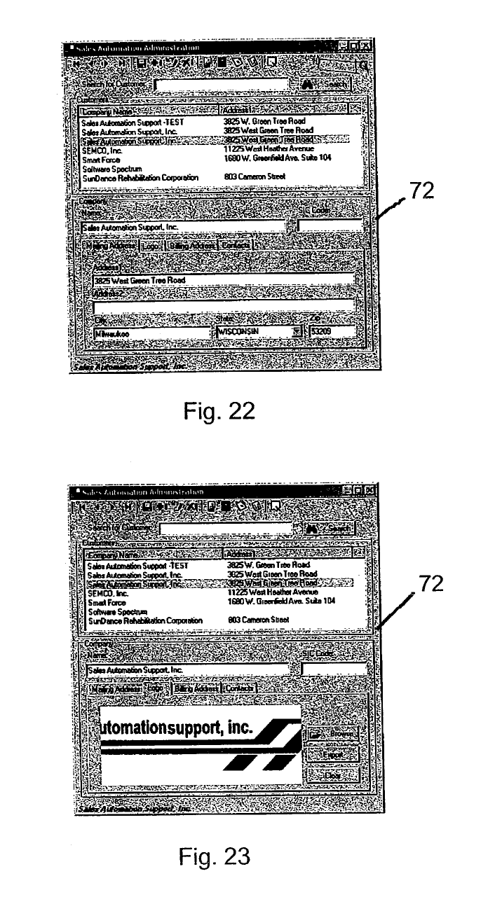

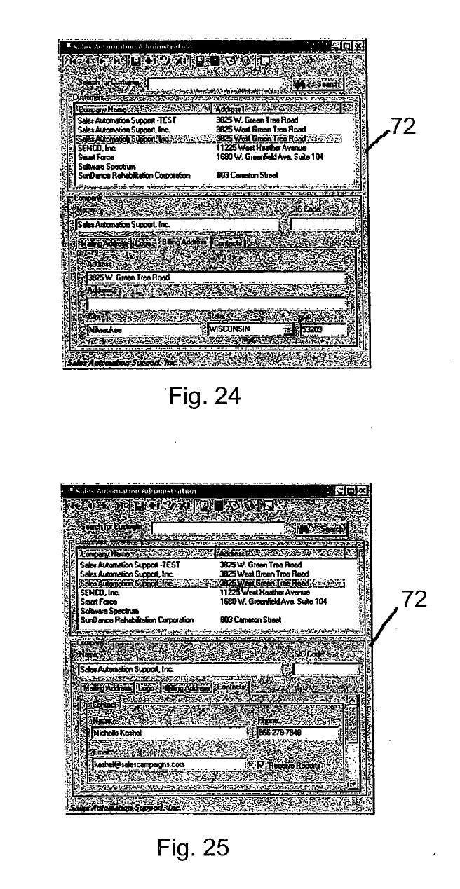

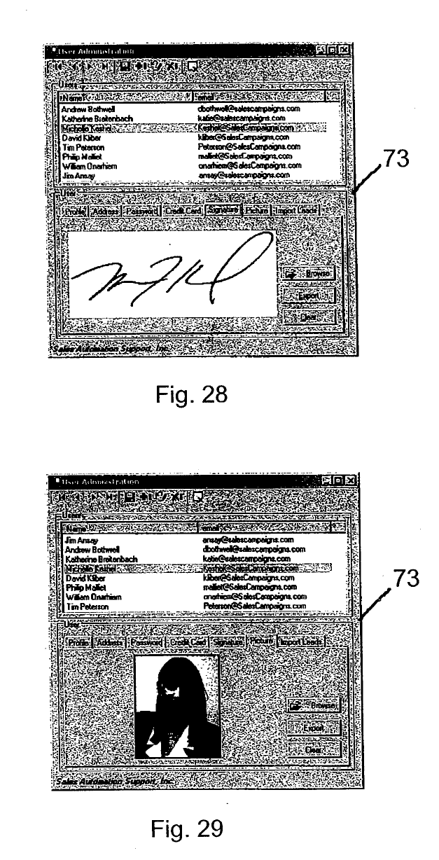

This correspondence selection process is best illustrated in FIGS. 22-36. For example, there are several remote subscriber support center system management tools. This system and its tools allow for easy access to all of the above-described data obtained from the mobile marketing module 25A and the sales support center 30.

First, a subscriber or customer administration submodule 72 automatically establishes reporting and billing accounts and stores company personalized information. The interface shown in FIGS. 22-25 illustrates that submodule 72 preferably has a search engine and captures company name and address information, SIC code information, the Company's logo, the billing information, and the contact at the Company including the contact's name, direct phone, and e-mail address. A blank box may be checked off if that contact person is authorized to receive regular reports.

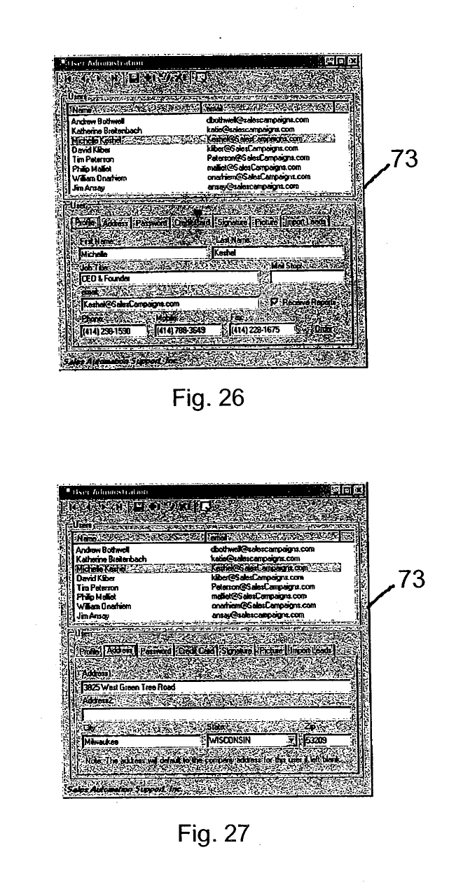

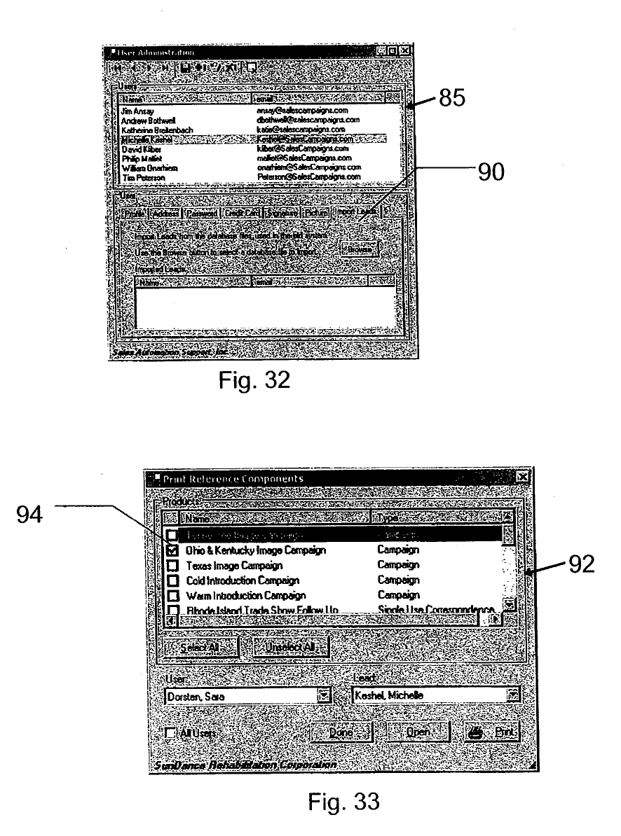

User information is captured through a user administration submodule 73 and interface. As illustrated in FIGS. 26-29, the user administration module automatically establishes user logon and reporting accounts and stores the user/sales representative's personalized information. A lookup table with all of the subscriber's sales reps and users names may be provided. Other accessible user information may consist of a profile with job title, email address, traditional mail stop address, office phone, mobile phone, fax number, and a receive reports check off box. There is also a link in this interface page for the user to place an order. Other information which may be captured in the user administration module includes user address, password, credit card or debit card information, signature, digitized photograph. An interface 85 as shown in FIG. 32 may also be accessed to import potential sales lead prospect information 90. Under an “import leads” tab, a lead injector may be used to import leads from existing lead or CRM databases. A browse button may be used to select this injector which allows for the importation of a database file.

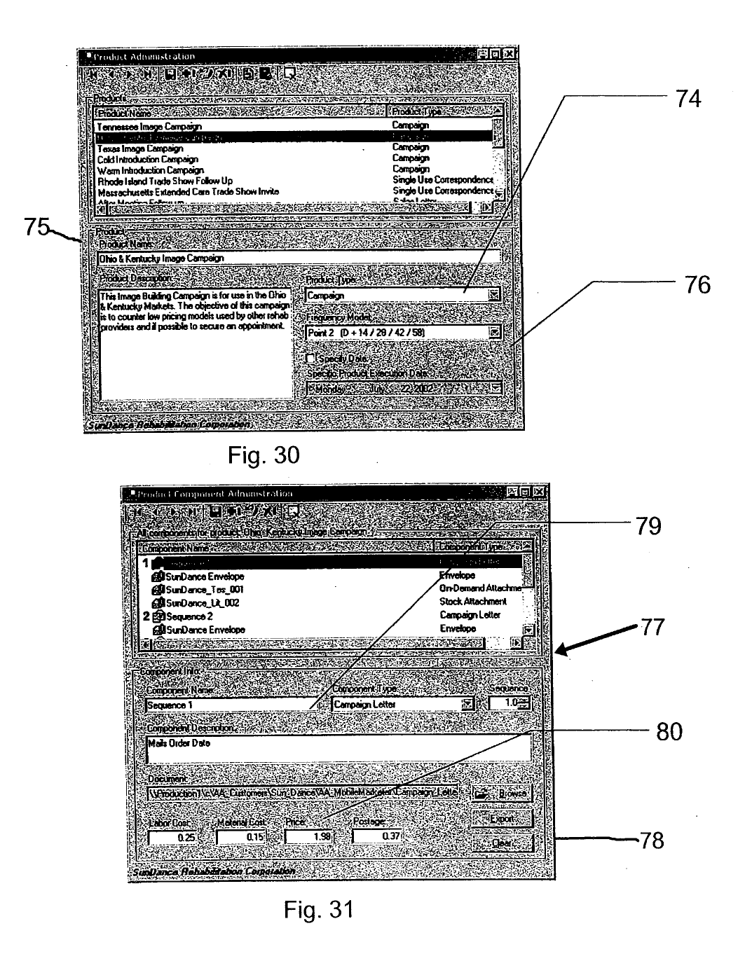

The global content manager submodule interface 75 shown in FIG. 30, manages correspondence and sales campaigns, such as production frequencies and timelines, and automatically populates user menus and interfaces for all devices. As illustrated by the user interface shown, a particular piece of campaign literature may be referenced as a “product” and has associated product information 74, e.g., product name and product type. For example, an Ohio and Kentucky image campaign is characterized as a “campaign” product type, a Rhode Island tradeshow follow-up is characterized as a product type “single use correspondence,” while an after meeting follow-up is characterized as a “sales letter.” Additional information included on this page includes a short product description for each product. This info may also be accessed from lookup table. A menu category selector lists each product type on the appropriate menu for all devices including web devices, mobile phones, pocket PCs, and blackberry devices. Mailing or follow-up frequency information 76 may be inputted into a frequency model.

A product component administration submodule 77 shown in FIG. 31 defines discrete correspondence, literature, and document components. As illustrated by the interface 78, once a campaign is selected a fulfillment component administration interface screen may be accessed. This interface screen shows component information 79, e.g., each individual component by name and component type. Examples include “Sequence 1” which is, e.g., a campaign letter, an envelope, a testimonial which is an on-demand attachment, a brochure or other piece of literature which is a stock attachment, etc. Other information 80 which may be displayed for each component includes the sequence default number, component description, the document's system address and cost information which may include labor costs, material costs, actual price to this subscriber, and postage fees. Of course there is the ability to browse information through this interface and export information therefrom. Costs of each of the components are tracked and managed at the discrete component and operational level. This data is also available through the automated billing report module interface.

There is also interface 92 (shown in FIG. 33) which allows the user to access and produce campaign guides for the various campaigns 94. In this interface 90, there is also a brief description guide for each product type. These descriptions act as a reference to all of the content that each user has available. The user has the ability to input their name and the lead's name in also. The documents may then be pulled up online to be read and searched. Of course, the guides and description my also be separately printed or mailed to the user.

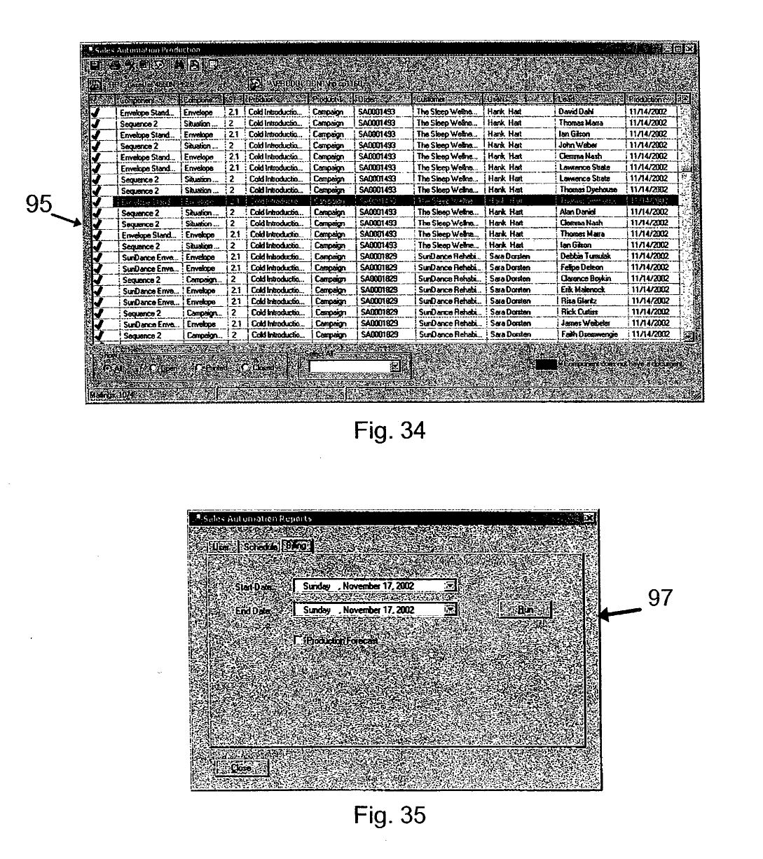

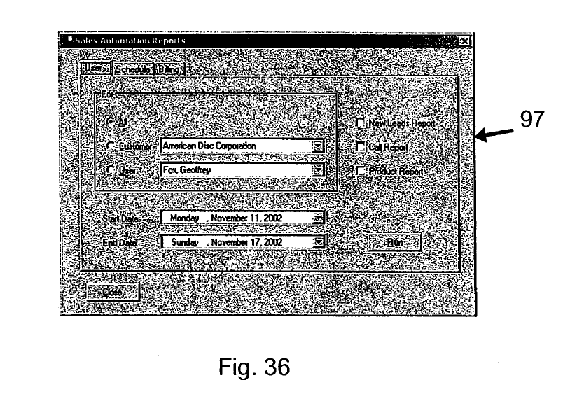

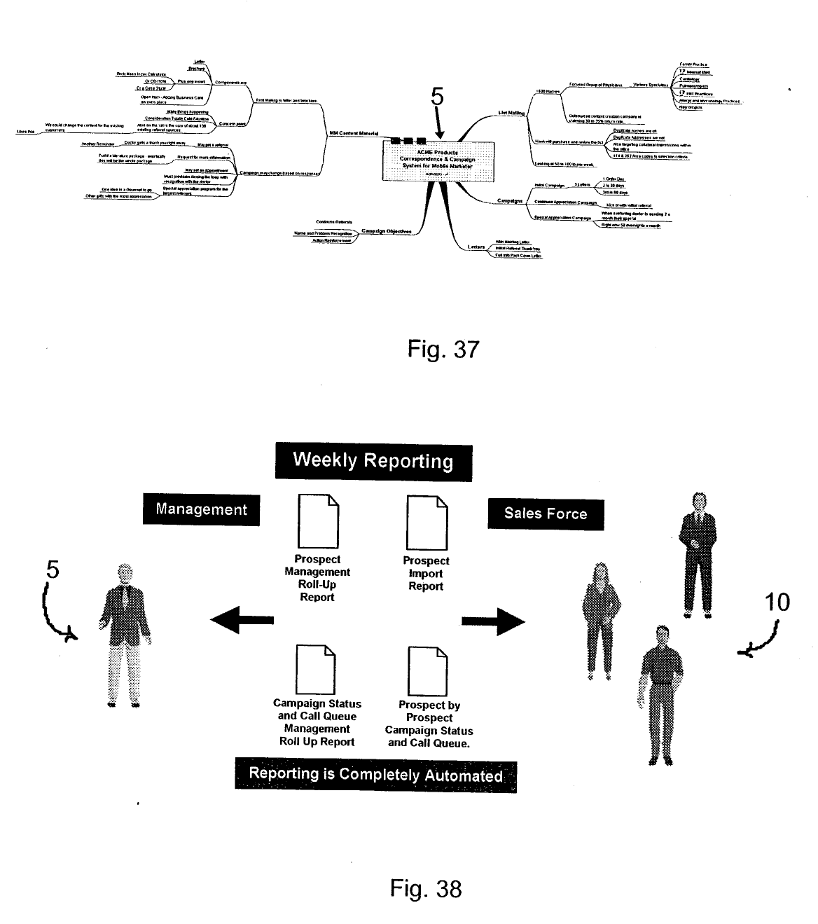

As shown in FIG. 34, an automated production and reporting module interface 95 is also preferably available to the sales support center. This module interface 95 helps manage queuing and production a daily basis. It also helps the production manager and operator identify attachments and stock literature for insertion in the mailing. This interface may also display the filing information component, component type, sequence, product type, product name, order number, subscriber were customer name user name, lead name, production date. As shown in FIGS. 35 and 36, from interface 97 other billing forecast reports for the user only in subscriber only may also be generated as shown in figures. These may include production forecast reports a new lead report, call reports, a product report, production schedule, and billing information, as well as stock dates stock dates additional customer and user information. These billing and production forecast reports are generally for internal use by the sales manager of the subscriber/customer to monitor the activities of the sales force users. Successes and costs of campaign can be tracked in this way for ROI purposes. As illustrated in FIG. 37, all of the system's subsystems, modules, and submodules connect to each other to seamlessly share data and move forward the sales campaign of the subscriber 5. For example, at the close of each subscriber session, the sales support center immediately merges the lead or prospect data into the selected communications template, merges the digital signature image on file into the selected communications template, and merges a reference to the selected “active lead” testimonial into the selected communications template. The sales support center then transmits the communication by electronic delivery if that option was selected. As best shown in FIGS. 8 and 9, if printed delivery was selected, the sales support center merges the prospect data onto an envelope, prints the envelope, matches the communication to the envelope, inserts the communication and seals the envelope, stamps the envelope, and delivers the envelope to the postal office the same day. The sales support center posts delivery verification to the subscriber's report as soon as delivery via e-mail or to the post office has been made.

The sales support center accesses prospect data, accesses the prospect data repository, and accesses automated marketing track selections based on an automatic “marketing business rules” schedule established by the subscriber. The sales support center merges prospect data into scheduled communications and transmits or prints/mails the communications as described above.

The terms for each data transfer transaction are defined in advance by the subscriber or their legal counsel and the sales support center invoices the subscriber for each data transfer transaction. The subscriber pays the sales support center with a credit card on file, an electronic funds transfer, or a company check.

Another option for subscribers and their users is the selection of “advanced documents” by the methods noted above, including wireless network internet access, land line based internet access, or call-in order, answering prompted questions or entering specific ROI elements of essential information. The sales support center captures the selections and entries, again storing them in a centralized database and producing the documentation requested using the process identified above. The invoice cycle proceeds as defined above.

B. Prospect Based Situation Interaction

When a prospect receives a communication via postal or electronic delivery, he or she may follow the link to the referenced “active lead” testimonial via an Internet browser connecting to the sales support center or may dial a voicemail server. The sales support center or its voicemail server supplies the prospect with an active lead web form or with voice testimonials. The prospect may enter data into the on-line form component, if available, or may respond to voice prompt queries in the voicemail option. In either case, the sales support center captures the prospect-entered data and stores it in a centralized database. The sales support center immediately processes any captured information according to the business rules established by the subscriber. This includes selection for notification via wireless delivery, email, or printed delivery verification. The sales support center further fulfills the prospect's information request and invoices the subscriber for testimonial delivery, additional surcharges for automated notification, or additional charges for prospect request fulfillment. The invoice is completed on the pre-approved terms and is paid as described above via credit card on file, electronic funds transfer, or company check. As shown in FIG. 38, various reports for subscribers 5 and users 10, can be then easily automatically generated on all account activity, e.g., weekly.

Although the best mode contemplated by the inventors of carrying out the present invention is disclosed above, practice of the present invention is not limited thereto. If will be manifest that various additions, modifications and rearrangements of the features of the present invention may be made without deviating from the spirit and scope of the underlying inventive concept.

Further, although various components are described herein is a physically separate modules, it will be manifest that the various module functions may be integrated into any other module. Furthermore, all the disclosed features of each disclosed embodiment can be combined with, or substituted for, the disclosed features of every other disclosed embodiment except where such features are mutually exclusive.

It is intended that the appended claims cover such additions, modifications and rearrangements. Expedient embodiments of the present invention are differentiated by the appended claims.

What is claimed is:

1. A mobile marketing system comprising:
a remote access module;
an initial contact data collection submodule operationally connected to the remote access system;
a database for storing contact data;
a data management submodule connected to the database for managing contact follow-up;
a ROI submodule connected to the database; and
a sales quote and configuration submodule connected to the database for preparing quotes for a prospect.

2. The mobile marketing system of claim 1 further comprising:
a content manager submodule for deploying templates for specific types of correspondence that are customized for each user and which includes a facility for automatically sequencing documents along a timeline that is specific to each mode of contact or preference on the part of said user for handling correspondence based on each identified situation over any defined period of time;
an print submodule connected to the data management module to provide automated and unattended fulfillment that consists of documents and communications that appear to the naked eye to have been personally prepared and in the case of printed documents, to be personally signed and mailed; and
a tracking submodule which records and retrieves the history of all correspondence by and between all correspondents and target prospects.

3. The mobile marketing system of claim 1 further comprising:
an access device integral with the access module comprising at least one of the following: personal computer, handheld computer, wireless access device, mobile phone, laptop computer, ATM machine, personal digital assistant, access enabled radio, television, and multimedia/broadband set top device; and
a system support center for fulfilling orders received through the remote access system.

4. A sales and marketing system comprising:
a subscriber remote access subsystem having a server computer;
a mobile marketing user subsystem having an access device; and
a sales support center subsystem having a server computer and a database to provide sales campaign and prospect data access, merge the two, and complete correspondence fulfillment.

5. A method of marketing comprising the steps of:
recording of information related to persons and organizations that are met or discovered by persons performing marketing or sales functions;
recording of correlated data related to probabilities of success at conducting business with persons and organizations that are met or discovered by persons performing marketing or sales functions;
recording of personal and organizational expenses related to the business activities of meeting, discovering or entertaining persons or organizations;
preparing, printing, mailing and/or transmitting correspondence directed to persons or organizations met or discovered by persons and organizations performing marketing or sales functions that are situational specific and related to past, and future meetings, events or acknowledgements;
preparing, printing, mailing and/or transmitting correspondence directed to persons or organizations met or discovered by persons and organizations performing marketing or sales functions that are situational specific and used to convey directions for a retrieval of information, instructions or testimonials delivered through printed, video and audio mediums;
preparing, printing, mailing and/or transmitting correspondence directed to persons or organizations met or discovered by persons and organizations performing marketing or sales functions that are situational specific and used to convey information related to a price or required configuration of products and/or services;
preparing, printing, mailing and/or transmitting correspondence directed to persons or organizations met or discovered by persons and organizations performing marketing or sales functions that are situational specific and used to convey information related proposed or recommended courses of action or intents; and
preparing, printing, mailing and/or transmitting correspondence directed to persons or organizations met or discovered by persons and organizations performing marketing or sales functions that are situational specific and used to convey information related to specific Return on Investment (ROI) Analysis reports as they relate to proposed or recommended courses of action and priced products, services or solutions.

6. A sales management system comprising:
a support submodule for item-by-item fulfillment schedules having variable frequency;
a submodule having the ability to manage item-by-item fulfillment schedules that consist of a number of total correspondences with a number of on-demand attachments, over any period of time which varies based on user selection;
a submodule having the ability to quickly change correspondence content to remain current with changing market conditions, new solutions, and new products, which, when operated, automatically, and nearly instantly deploys new correspondence models for selection and use by any of the systems users regardless of location, or input device;
submodule for item-by-item, one-to-one campaign fulfillment that is billed based on the same price to send any individual letter, literature item or sample as each event occurs; and
a submodule for weekly call queue and campaign status reports that are transmitted direct to a user.
